(19) United States
(12) Patent Application Publication
(10) Pub. No.: US 2026/0227759 A1
(43) Pub. Date: Aug. 6, 2026

(54) Model Based Engineering Machining

(71) Applicant: The Boeing Company, Arlington, VA (US)

(72) Inventors: Justin Lee Peters, Carrollton, IL (US); Luke A. Berglind, St. Louis, MO (US); Jared L. Bolin, Millstadt, IL (US)

(21) Appl. No.: 19/224,074

(22) Filed: May 30, 2025

Related U.S. Application Data
(60) Provisional application No. 63/753,234, filed on Feb. 3, 2025.

(51) Int. Cl. G05B 19/4097

(52) U.S. Cl. CPC G05B 19/4097; G05B 2219/35012; G05B 2219/35017

(57) ABSTRACT

A method for manufacturing a workpiece. A job is created as part of a workflow to manufacture the workpiece using a numeric control machine. The job identifies tasks in the workflow to manufacture the workpiece. A standardized computer-aided design model is created in a standardized format from a computer-aided design model and stored in a digital thread. Simulations are performed using information in the digital thread used as inputs to obtain simulation results. The information is in a simulator format used by each of the simulators. The simulation results are stored in the standardized format in the digital thread. A numeric control program in a numeric control machine format utilized by the numeric control machine is created using product manufacturing information and geometry for the workpiece in the standardized computer-aided design model in the digital thread. The workpiece is manufactured using the numeric control program and the numeric control machine.

### CROSS-REFERENCE TO RELATED APPLICATION

This application claims the benefit of U.S. Provisional Patent Application Ser. No. 63/753,234, filed Feb. 3, 2025, and entitled “Model Based Engineering Machining,” which is incorporated herein by reference in its entirety.

### BACKGROUND INFORMATION

### 1. Field

The present disclosure relates generally to part manufacturing and in particular, to machining parts using model based engineering.

### 2. Background

Parts are manufactured using different manufacturing techniques. For example, parts can be manufactured using machining in which a machine operates to remove material from a blank or a fabrication piece to create the part. Model based engineering (MBE) machining can be used to manufacture parts from digital three dimensional models of the parts.

With model based engineering machining, a computer-aided design model (CAD) and product manufacturing information are used by a computer-aided manufacturing (CAM) system to generate tool paths, manage tolerances, and manage workflows for product manufacturing information. The computer-aided manufacturing (CAM) system can generate a program comprising program instructions that are used to guide and control the operation of a numeric control (NC) machine. A numeric control machine can be a lathe, a mill, a router, or other suitable tools that operate to create parts having dimensions within desired tolerances.

The program generated by the computer-aided manufacturing system specifies tool paths, feed rates, spindle speeds, coding sequences, and other information used to machine materials to form parts. This type of machine using a program generated from a computer-aided design model can provide high levels of precision with repeatability to manufacture parts from different materials including aluminum, steel, plastics, and composites.

### SUMMARY

An embodiment of the present disclosure provides a manufacturing system comprising a computer system and a workflow manager in the computer system. The workflow manager is configured to perform operations for a workflow to manufacture a part in which the operations comprise creating a job to manufacture the part using a numeric control machine; creating a standardized computer-aided design model in a standardized format from a computer-aided design model for the part, wherein the standardized computer-aided design model includes product manufacturing information and geometry for the part; storing the standardized computer-aided design model in a digital thread; creating a mesh model in a finite element analysis format utilized by a finite element analysis program using the standardized computer-aided design model; running a finite element analysis simulation for the part using the mesh model and finite element analysis program to obtain finite element analysis simulation results; storing the finite element analysis simulation results from the finite element analysis simulation in the standardized format in the digital thread; creating a numeric control program in a numeric control machine format utilized by the numeric control machine using the standardized computer-aided design model; performing a manufacturing simulation of the part using the numeric control program and the numeric control machine to generate manufacturing simulation results in the standardized format; storing the manufacturing simulation results in the standardized format in the digital thread; and manufacturing the part using the numeric control program and the numeric control machine.

A manufacturing system comprising a computer system, a digital thread in the computer system, and a workflow manager in the computer system. The digital thread stores information for manufacturing a workpiece. The information in the digital thread is in a standardized format. The is configured to perform operations for a workflow to manufacture the workpiece in which the operations comprise creating a job to manufacture the workpiece using a numeric control machine, wherein the job identifies tasks in the workflow to manufacture the workpiece creating a standardized computer-aided design model in the standardized format from a computer-aided design model for the workpiece, wherein the standardized computer-aided design model is stored in the digital thread; performing a number of simulations in the workflow using information in the digital thread used as inputs to a number of simulators to obtain simulation results, wherein the information is in a simulator format used by each of the number of simulators and wherein the simulation results are stored in the standardized format in the digital thread; creating a numeric control program in a numeric control machine format utilized by the numeric control machine using product manufacturing information and geometry for the workpiece in the standardized computer-aided design model in the digital thread; and manufacturing the workpiece using the numeric control program and the numeric control machine.

Another embodiment of the present disclosure provides a method for manufacturing a part. A job is created as part of a workflow to manufacture the part using a numeric control machine. A standardized computer-aided design model is created in a standardized format from a computer-aided design model for the part. The standardized computer-aided design model includes product manufacturing information and geometry for the part. The standardized computer-aided design model is stored in a digital thread. A mesh model in a finite element analysis format utilized by a finite element analysis program is created using the standardized computer-aided design model. A finite element analysis simulation for the part is run using the mesh model and finite element analysis program to obtain finite element analysis simulation results. The finite element analysis simulation results from the finite element analysis simulation is stored in the standardized format in the digital thread. A numeric control program in a numeric control machine format utilized by the numeric control machine is created using the standardized computer-aided design model. A manufacturing simulation of the part is performed using the numeric control program for the numeric control machine to generate manufacturing simulation results in the standardized format. The manufacturing simulation results are stored in the standardized format in the digital thread. The part is manufactured using the numeric control program and the numeric control machine.

Still another embodiment of the present disclosure provides a method for manufacturing a workpiece. A job is created as part of a workflow to manufacture the workpiece using a numeric control machine. The job identifies tasks in the workflow to manufacture the workpiece. A standardized computer-aided design model is created in a standardized format from a computer-aided design model for the workpiece, wherein the standardized computer-aided design model is stored in a digital thread. A number of simulations is performed in the workflow using information in the digital thread used as inputs to a number of simulators to obtain simulation results. The information is in a simulator format used by each of the number of simulators and wherein the simulation results are stored in the standardized format in the digital thread. A numeric control program in a numeric control machine format utilized by the numeric control machine is created using product manufacturing information and geometry for the workpiece in the standardized computer-aided design model in the digital thread. The workpiece is manufactured using the numeric control program and the numeric control machine.

Yet another embodiment of the present disclosure provides a computer program product for manufacturing a workpiece. The computer program product comprises a set of one or more computer-readable storage media and program instructions stored on the set of one or more storage media to perform operations comprising creating a job as part of a workflow to manufacture the workpiece using a numeric control machine, wherein the job identifies tasks in the workflow to manufacture the workpiece; creating a standardized computer-aided design model in a standardized format from a computer-aided design model for the workpiece, wherein the standardized computer-aided design model is stored in a digital thread; performing a number of simulations in the workflow using information in the digital thread used as inputs to a number of simulators to obtain simulation results, wherein the information is in a simulator format used by each of the number of simulators and wherein the simulation results are stored in the standardized format in the digital thread; creating a numeric control program in a numeric control machine format utilized by the numeric control machine using product manufacturing information and geometry for the workpiece in the standardized computer-aided design model in the digital thread; and manufacturing the workpiece using the numeric control program and the numeric control machine.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is an illustration of a block diagram of a manufacturing environment in accordance with an illustrative embodiment;

FIG. 3 is an illustration of a block diagram of a standardized format in accordance with an illustrative embodiment;

FIG. 4 is an illustration of a dataflow for providing interoperability between different systems in accordance with an illustrative embodiment;

FIG. 5 is an illustration of a graphical user interface for manufacturing parts in accordance with an illustrative embodiment;

FIG. 6 is an illustration of a process flow for performing tasks to manufacture an aluminum part in accordance with an illustrative embodiment;

FIG. 7 is an illustration of a process flow for manufacturing a physical machine part in accordance with an illustrative embodiment;

FIG. 8 is an illustration of a flowchart of a process for manufacturing a part in accordance with an illustrative embodiment;

FIG. 9 is an illustration of a flowchart of a process for inspecting a part in accordance with an illustrative embodiment;

FIG. 10 is an illustration of a flowchart of a process for generating a quote in accordance with an illustrative embodiment;

FIG. 11 is an illustration of a flowchart of a process for saving metadata in accordance with an illustrative embodiment;

FIG. 12 is an illustration of a flowchart of a process for creating shop documentation in accordance with an illustrative embodiment;

FIG. 13 is an illustration of a flowchart of a process for creating a standardized computer-aided design model in accordance with an illustrative embodiment;

FIG. 14 is an illustration of a flowchart of a process for creating a numeric control program in accordance with an illustrative embodiment;

FIG. 15 is an illustration of a flowchart of a process for creating a numeric control program in accordance with an illustrative embodiment;

FIG. 16 is an illustration of a flowchart of a process for manufacturing a part in accordance with an illustrative embodiment;

FIG. 17 is an illustration of a flowchart of a process for inspecting a workpiece in accordance with an illustrative embodiment;

FIG. 18 is an illustration of a flowchart of a process for creating quote information in accordance with an illustrative embodiment;

FIG. 19 is an illustration of a flowchart of a process for performing a number of simulations in a workflow in accordance with an illustrative embodiment;

FIG. 20 is an illustration of a flowchart of a process for performing a number of simulations in a workflow in accordance with an illustrative embodiment;

FIG. 21 is an illustration of a flowchart of a process for performing a number of simulations in a workflow in accordance with an illustrative embodiment;

FIG. 22 is an illustration of a flowchart of a process for manufacturing a workpiece in accordance with an illustrative embodiment;

FIG. 23 is an illustration of a flowchart of a process for creating a numeric control program in accordance with an illustrative embodiment;

FIG. 24 is an illustration of a flowchart of a process for creating a numeric control program in accordance with an illustrative embodiment;

FIG. 25 is an illustration of a block diagram of a data processing system in accordance with an illustrative embodiment;

FIG. 26 is an illustration of an aircraft manufacturing and service method in accordance with an illustrative embodiment;

FIG. 27 is an illustration of a block diagram of an aircraft in which an illustrative embodiment may be implemented; and

FIG. 28 is an illustration of a block diagram of a product management system in accordance with an illustrative embodiment.

### DETAILED DESCRIPTION

The illustrative embodiments recognize and take into account one or more different considerations as described herein. For example, many different types of computer-aided design systems, computer-aided manufacturing systems, simulation programs, and other software can be used in manufacturing as part of a model-based engineering machine. Multiple types of computer-aided design programs may be used within a single organization of business. Also, multiple types of simulation programs for finite element analysis, machine simulations, and other types of simulations are present. These systems often use different formats models, input data, output data, and other information.

Also, these different systems are often used in different departments or groups manufacturing a part. For example, a design team may create the initial part design using a computer-aided design software system. This design can be analyzed by another team that performs a finite element analysis to determine the structural integrity, thermal properties, and other information about the design. In some cases, the format of the computer-aided design model may not be compatible with the simulation tool or finite element analysis software. As a result, additional processing is often needed in these situations to perform the analysis.

Another group in the organization may perform program generation to generate the numeric control program for use by the numeric control machine. This type of program generation often involves a computer-aided manufacturing software that generates the program using the computer-aided design model as an input. Format incompatibilities may result in increased processing and time needed to generate the numeric control program. As a result, the speed at which parts can be manufactured may be slowed down reducing efficiency in the manufacturing process.

Thus, these situations can involve data format incompatibility in which computer-aided design models cannot be seamlessly used as inputs to a finite element analysis tool or computer-aided manufacturing system. As a result, the interoperability of different software systems may be more difficult than desired to manufacture parts using numeric control machines.

The illustrative embodiments provide a method, apparatus, system, and computer program products for manufacturing workpieces. In one illustrative example, method manufactures a workpiece. A job is created as part of a workflow to manufacture the workpiece using a numeric control machine. The job identifies tasks in the workflow to manufacture the workpiece. A standardized computer-aided design model is created in a standardized format from a computer-aided design model for the workpiece, wherein the standardized computer-aided design model is stored in a digital thread. A number of simulations is performed in the workflow using information in the digital thread used as inputs to a number of simulators to obtain simulation results.

As used herein, a “number of” when used with reference items means one or more items. For example, a number of simulations is one or more simulations. As another example, a number of simulators is one or more simulators.

The information is in a simulator format used by each of the number of simulators and wherein the simulation results are stored in the standardized format in the digital thread. A numeric control program is created in a numeric control machine format utilized by the numeric control machine using product manufacturing information and geometry for the workpiece in the standardized computer-aided design model in the digital thread. The workpiece is manufactured using the numeric control program and the numeric control machine.

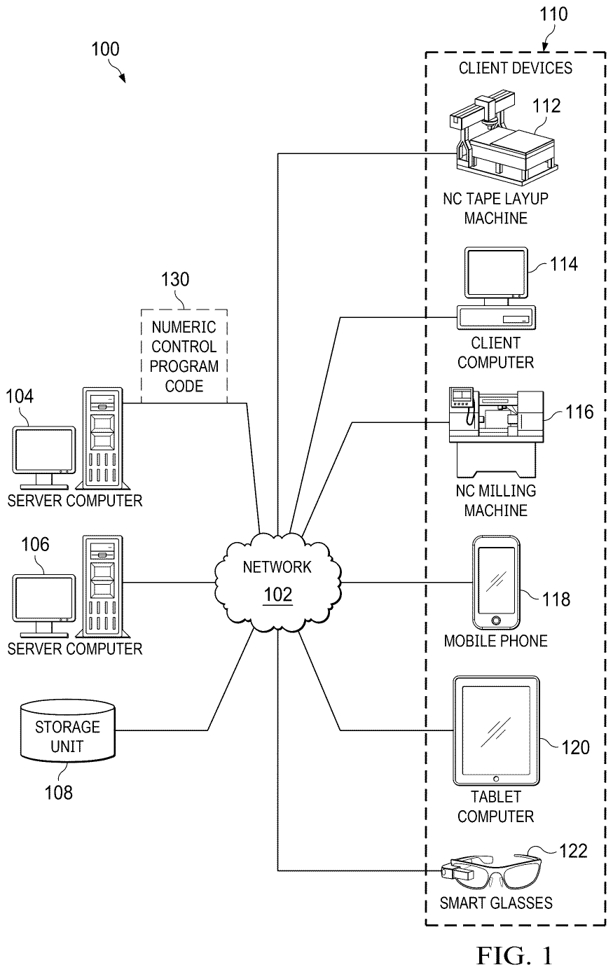

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. Client devices 110 can be, for example, computers, workstations, network computers, vehicles, machinery, appliances, or other devices that can process data. As depicted, client devices 110 include numeric control (NC) tape layup machine 112, client computer 114, numeric control (NC) milling machine 116, mobile phone 118, tablet computer 120, and smart glasses 122. Client devices 110 can be, for example, computers, workstations, network computers, numeric control machines, or other machines or objects that include processing resources that can run program code. In the depicted example, server computer 104 provides information, such as boot files, operating system images, and applications to client devices 110.

Further, in this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage medium and downloaded to a data processing system or other device for use. For example, program instructions can be stored on a computer-recordable storage medium on server computer 104 and downloaded to client devices 110 over network 102 for use on client devices 110.

In the depicted example, server computer 104 provides information, such as boot files, operating system images, and applications to client devices 110. For example, server computer 104 generates information in the form of numeric control program code 130 that can be sent to NC tape layup machine 112 and NC milling machine 116. Numeric control program code 130 is run by these numeric control machines to manufacture workpieces.

For example, NC tape layup machine 112 can manufacture a workpiece in the form of ply stack as part of an automatic tape laying process performed using numeric control program code 130.

As another example, NC milling machine 116 can run numeric control program code 130 to remove material from stock or a blank in which cutting tools moves along paths in multiple axes. This type of machine can perform drilling, milling, chamfering, contouring, and other operations to form various workpieces such as aircraft parts. For example, these aircraft parts include at least one of a wing rib, a fuselage panel, a wear plate, a hex lock support, a housing, and an engine mount.

In the depicted example, network data processing system 100 is the Internet with network 102 representing a worldwide collection of networks and gateways that use the Transmission Control Protocol/Internet Protocol (TCP/IP) suite of protocols or other networking protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

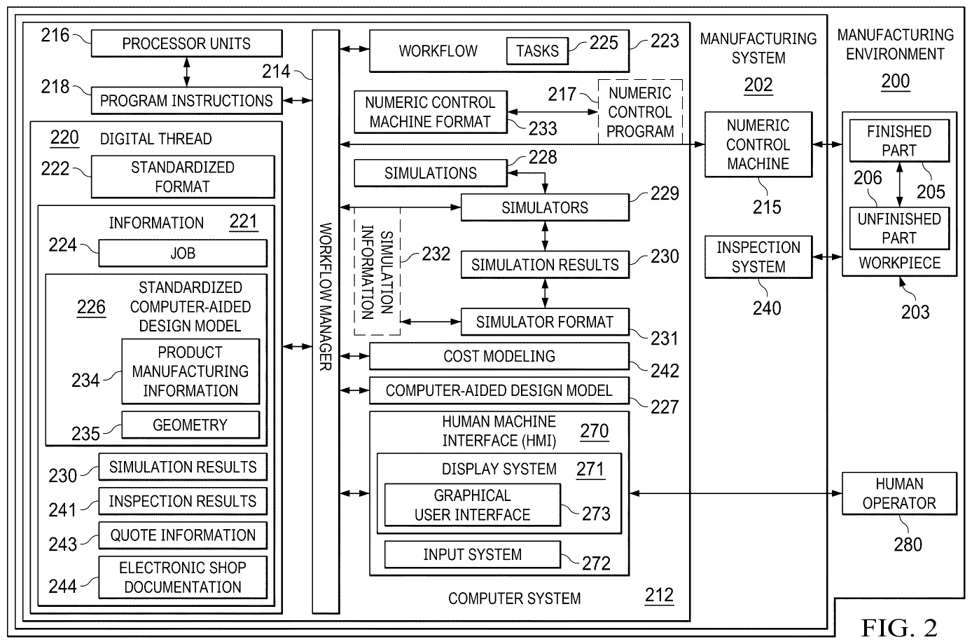

With reference now to FIG. 2, an illustration of a block diagram of a manufacturing environment is depicted in accordance with an illustrative embodiment. In this illustrative example, manufacturing environment 200 includes components that can be implemented in hardware such as the hardware shown in network data processing system 100 in FIG. 1.

In this example, manufacturing system 202 can operate to manufacture workpiece 203. In this illustrative example, workpiece 203 is a material or component that is processed to obtain a desired shape, structure, or function. Workpiece 203 can be finished part 205 or unfinished part 206. As finished part 205, workpiece 203 is a fully finished component that is ready for use. In other examples, workpiece 203 is in the form of unfinished part 206, which is a partially finished component that needs further file processing to form finished part 205. Unfinished part 206 can be, for example, a prepreg, a ply stack, layers of tape, a partially machined blank, or other components that are further processed to generate finished part 205.

In this illustrative example, manufacturing system 202 includes a number of different components. As depicted, manufacturing system 202 comprises computer system 212, workflow manager 214, numeric control machine 215, and digital thread 220. Workflow manager 214 is located in computer system 212.

Workflow manager 214 can be implemented in software, hardware, firmware or a combination thereof. When software is used, the operations performed by workflow manager 214 can be implemented in program instructions configured to run on hardware, such as a processor unit. When firmware is used, the operations performed by workflow manager 214 can be implemented in program instructions and data and stored in persistent memory to run on a processor unit. When hardware is employed, the hardware can include circuits that operate to perform the operations in workflow manager 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

Numeric control machine 215 is a hardware system that also includes software. This machine operates to manufacture workpiece 203. Numeric control machine 215 can be any computer-controlled machine that uses a software program to automate the manufacturing of workpiece 203. In this example, numeric control machine 215 uses numeric control program 217 to perform manufacturing operations on workpiece 203 without needing guidance from human operator 280.

In this illustrative example, numeric control program 217 comprises program instructions that are for use by numeric control machine 215 to provide instructions to manufacture workpiece 203. These instructions provided by numeric control program 217 can include at least one of a machine movement for a cutting tool, a machine movement for a workpiece, a feed rate, or other operations related to the manufacturing workpiece 203.

In this illustrative example, numeric control program 217 can be geometric code (G-code) that specifies the different movements of components in numeric control machine 215 to manufacture workpiece 203. In this example, G-code is defined by ISO 6983, which is an international standard defining programming language and data format used by numeric control machines. These movements can define paths of the tool used to manufacture workpiece 203.

In other examples, numeric control program 217 can take other forms or formats in addition to G-code that provide instructions to control the operation of numeric control machine 215 to manufacture workpiece 203. For example, other forms of numeric control program 217 can be selected from at least one of a script, programmable logic controller (PLC) code, extensible markup language (XLM) proprietary machine code, or other types of program code.

Digital thread 220 is a connected flow of data that provides information for workpiece 203. In this example, digital thread 220 stores information 221 for manufacturing workpiece 203. Information 221 in digital thread 220 is in standardized format 222.

In this illustrative example, workflow manager 214 performs operations for workflow 223 to manufacture workpiece 203. In performing these operations, workflow manager 214 creates job 224 to manufacture workpiece 203 using numeric control machine 215. Job 224 identifies tasks 225 in workflow 223 to manufacture workpiece 203. In this example, job 224 is stored as information 221 in digital thread 220 using standardized format 222.

Workflow manager 214 also can create standardized computer-aided design model 226 in standardized format 222 from computer-aided design model 227 for the workpiece. In this example, standardized computer-aided design model 226 is information 221 stored in digital thread 220. As depicted, computer-aided design model 227 may be obtained from another source. For example, computer-aided design model 227 may be output from the computer-aided design system. In another example, computer-aided design model 227 may be stored in a database of models.

Workflow manager 214 performs a number of simulations 228 in workflow 223 using information 221 in digital thread 220 used as inputs to a number of simulators 229 to obtain simulation results 230. Simulation results 230 is in simulator format 231 used by each of the number of simulators 229. Simulation results 230 are stored in standardized format 222 in digital thread 220.

In performing the number of simulations 228, workflow manager 214 creates simulation information 232 from information 221 in digital thread 220 as inputs to the number of simulators 229. In this example, simulation information 232 is simulator format 231 utilized by each of the number of simulators 229. Workflow manager 214 sends simulation information 232 as the inputs to the number of simulators 229.

Workflow manager 214 initiates the number of simulators 229 to perform the number of simulations 228 for workpiece 203 using simulation information 232 to obtain simulation results 230. Workflow manager 214 stores simulation results 230 in standardized format 222 in digital thread 220.

In this illustrative example, workflow manager 214 creates numeric control program 217 in numeric control machine format 233 utilized by numeric control machine 215 using product manufacturing information 234 and geometry 235 for workpiece 203 in information 221 in digital thread 220. In this example, product manufacturing information 234 and geometry 235 for workpiece 203 are located in standardized computer-aided design model 226 in digital thread 220.

In this illustrative example, product manufacturing information 234 can be used directly or used to determine information needed to generate numeric control program 217. For example, product manufacturing information 234 can include at least one of dimensions, tolerances, material specifications, surface finish requirements, coordinate systems, or material specifications. Geometry 235 for workpiece 203 includes features such as edges, surfaces, holes, and pockets, which correspond to machining operations.

In this example, stating that product manufacturing information 234 and geometry 235 for workpiece 203 are located in standardized computer-aided design model 226 means that geometry 235 for workpiece 203 are located in standardized computer-aided design model 226. In some examples, both of product manufacturing information 234 and geometry 235 are located in standardized computer-aided design model 226.

In this illustrative example, workflow manager 214 manufactures workpiece 203 using numeric control program 217 and numeric control machine 215. For example, workflow manager 214 can send numeric control program 217 to numeric control machine 215 with a command to initiate manufacturing of workpiece 203.

After manufacturing workpiece 203, workflow manager 214 can inspect workpiece 203 using inspection system 240 to generate inspection results 241. Inspection system 240 can be, for example, a coordinate measurement system (CMM), an optical measurement system, a computed tomography system, a laser scanner, a three-dimensional scanner, an ultrasonic inspection system, and other suitable types of systems. Workflow manager 214 saves inspection results 241 in standardized format 222 in digital thread 220 as part of information 221.

Further, workflow manager 214 can also perform cost modeling 242 using simulation results 230 to create quote information 243 as part of performing tasks 225 in workflow 223. Simulation results 230 can provide information such as machining time, tool wear, material usage, energy consumption, and rework rates. These results can be combined with cost factors such as hourly machine rates, labor costs, tooling expenses, and material prices to estimate costs for workpiece 203. This approach enables identifying cost drivers, optimizing machining strategies to reduce expenses while maintaining quality and efficiency. As depicted, quote information 243 is also stored by workflow manager 214 in digital thread 220 as part of information 221 in standardized format 222.

Further, the creation of quote information 243 can also involve using cost information for a particular numeric control machine or customer data. For example, the cost can be different for manufacturing workpiece 203 when numeric control machine 215 is complex versus being a simple machine.

Further, this cost can be, for example, the rate at which workpiece 203 can be manufactured using numeric control machine 215. Further, the cost can also be determined based on simulation results 230 from simulating manufacturing workpiece 203.

For example, tools used, tool wear, errors, anomalies in workpieces, materials used, and other information from simulation results 230 resulting from a simulation of the manufacturing of workpiece 203 can be used in cost modeling 242 to generate quote information 243. This and other information can be used to determine the cost to manufacture workpiece 203.

Workflow manager 214 can create electronic shop documentation 244 using simulation results 230. This documentation is stored as part of information 221 in digital thread 220 using standardized format 222. In this illustrative example, electronic shop documentation 244 can be used by at least one of the robotic system or a human operator to identify at least one of set up information, tools used, blanks, stock, or other items needed for numeric control machine 215 to manufacture workpiece 203 using numeric control program 217.

In one example, a robotic system can select and set up one or more tools on numeric control machine 215. Set up information can be used to set configuration settings for numeric control machine 215. This setup can be performed by a robotic system or workflow manager 214.

In these illustrative examples, digital thread 220 ensures that all information generated during the tasks performed for manufacturing processes for workpiece 203 are interconnected and accessible. Digital thread 220 can be sent to a system selected from at least one of a product lifecycle management system or enterprise resource planning (ERP) system. Digital thread 220 can be integrated into a product digital thread for a product in which workpiece 203 is located or used. Digital thread 220 can be added to or integrated with this product digital thread to provide information about a product lifecycle from design, manufacturing, operation, maintenance, and other parts of the lifecycle. This comprehensive collection of information in the product digital thread can improve efficiency, reduce errors, and better enable decision-making by providing a single source for a product lifecycle.

In this illustrative example, human machine interface (HMI) 270 is an interface system that can be used by human operator 280 to interact with different components in computer systems 212. This interface can be located on the same computing device or a different computing device from workflow manager 214 in computer system 212. As depicted, human machine interface 270 comprises display system 271 and input system 272.

Display system 271 is a physical hardware system and includes one or more display devices on which graphical user interface 273 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

Human operator 280 is a person that can interact with graphical user interface 273 through user input generated by input system 272 for computer system 212. Input system 272 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device.

In this example, human operator 280 can use human machine interface 270 to select a particular workpiece for manufacturing using manufacturing system 202. Further, human operator 280 can also view and analyze information within digital thread 220 using human machine interface 270. For example, human operator 280 can view at least one of simulation results 230, inspection results 241, quote information 243, or electronic shop documentation 244 for job 224 to manufacture workpiece 203. In one example, workflow manager 214 can display the number of simulations 228 on human machine interface 270. Workflow manager 214 can also display simulation results 230 on human machine interface 270.

In one illustrative example, one or more technical solutions are present that overcome a technical problem with manufacturing workpieces using different systems that may employ different standards or formats for information needed to perform tasks in a workflow to manufacture the workpieces. As a result, one or more technical solutions may provide a technical effect increasing the interoperability between different components in a manufacturing system. This increase in interoperability can be enabled through the use of a digital thread in which information is stored using a standardized format. The information can then be translated or converted into forms used by different systems during the performance of the workflow to manufacture a workpiece.

Computer system 212 can be configured to perform at least one of the steps, operations, or actions described in the different illustrative examples using software, hardware, firmware or a combination thereof. As a result, computer system 212 operates as a special purpose computer system in which workflow manager 214 in computer system 212 enables more efficiently performed tasks in a workflow to manufacture a workpiece using a numeric control machine. In particular, workflow manager 214 transforms computer system 212 into a special purpose computer system as compared to currently available general computer systems that do not have workflow manager 214.

In the illustrative example, the use of workflow manager 214 in computer system 212 integrates processes into a practical application for generating program code to manufacture a workpiece such as finished part 205 or unfinished part 206. The result of this process is program code generated in computer system 212 that can be used in a practical application for manufacturing workpieces using a numeric control machine.

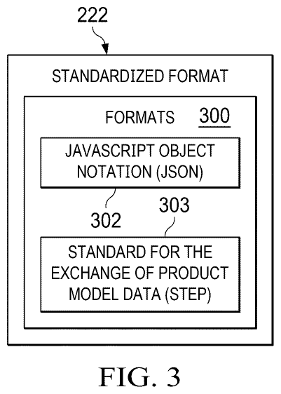

Right next to FIG. 3, an illustration of a block diagram of a standardized format is depicted in accordance with an illustrative embodiment. In the illustrative examples, the same reference numeral may be used in more than one figure. This reuse of a reference numeral in different figures represents the same element in the different figures.

In this illustrative example, an example of an implementation for standardized format 222 is shown. As depicted, standardized format 222 can be comprised of a number of formats 300 in standardized information 221. For example, formats 300 in standardized format 222 can include JavaScript Object Notation (JSON) 302 and Standard for the Exchange of Product model data (STEP) 303. This format can be used to generate STEP files such as STEP 238 or STEP 242.

In this illustrative example, JavaScript Object Notation (JSON) 302 is a text based data interchange format in which data can be represented as key-value pairs, arrays, or nested structures. This type of standard can be used to store information such as program code, sensor data, simulation results such as parameters and outcomes, quotes, and other information that may be stored in digital thread 220.

Standard for the Exchange of Product model data (STEP) 303 is defined using ISO 10303. This format can be used to store models such as computer-aided design (CAD) models used in CAD systems, computer-aided manufacturing (CAM) models used in CAM systems, meshes used in simulations, as well as other models.

With formats 300 in standardized format 222, information can be converted into formats used by particular systems selected from at least one of a simulator, a computer-aided model system, a computer-aided manufacturing system, a maintenance planning system, a lifecycle management system, an enterprise resource planning (ERP) system, or other systems in which these different systems use different formats for receiving and using information.

Formats 300 depicted in standardized format 222 in this figure is presented as an example of a standardized format and not meant to limit the manner in which standardized format 222 can be implemented in other examples. For example, extensible markup language (XML) can be used in place of or in addition to JavaScript object notation 302 and other examples as a standard format for test results, documents, and other information in digital thread 220.

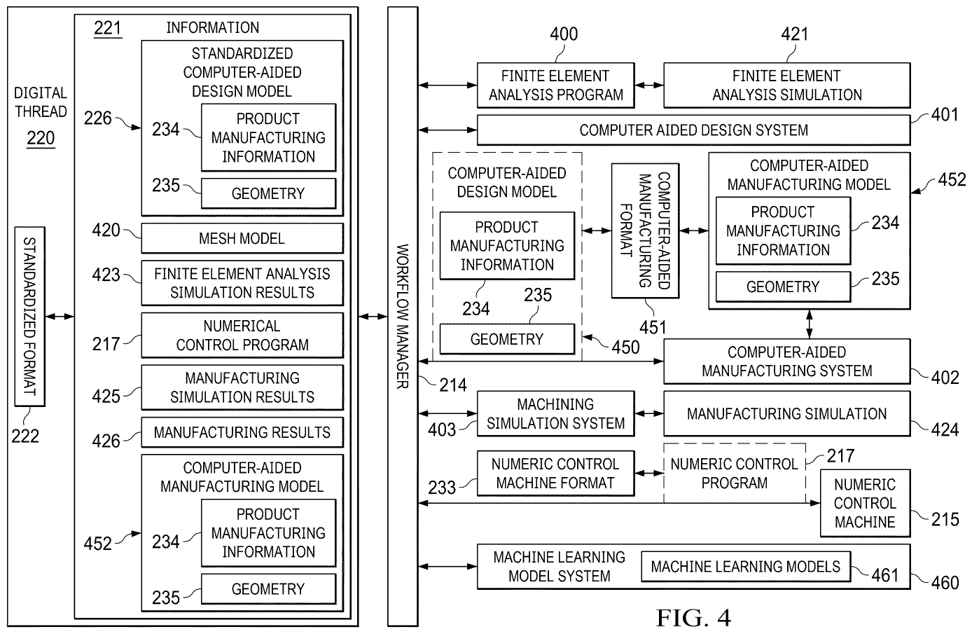

Running next to FIG. 4, an illustration of a dataflow for providing interoperability between different systems is depicted in accordance with an illustrative embodiment. In this illustrative example, workflow manager 214 manages the operation and dataflow used in the operation of different systems. As depicted, the systems include finite element analysis program 400, computer-aided design system 401, computer-aided manufacturing system 402, machining simulation system 403, and numeric control machine 215. As depicted, the systems include software and hardware to run the software. For example, computer-aided design system 401 comprises computer-aided design software and one or more computers that run the computer-aided design software.

The dataflow depicted in this illustrative example is implemented with workflow manager using digital thread 220 that stores information 221 in standardized format 222. In this example, digital thread 220 can be used to store all information generated during the performance of tasks 225 in workflow 223. This information includes data, simulation results, models, programs, and other types of information.

For example, workflow manager 214 creates mesh model 420 in a finite element analysis format utilized by finite element analysis program 400 using standardized computer-aided design model 226. In this example, geometry 235 in standardized computer-aided design model 226 can be used to generate mesh model 420. Mesh model 420 can be stored in standardized format 222 in digital thread 220. Further, this mesh model can also be converted into a format used by finite element analysis program 400. By storing mesh model 420 in standardized format 222 in digital thread 220, this mesh model can be used again at a later point in time by another finite element analysis program 420 that may use a different format from finite element analysis program 400.

Workflow manager 214 then performs a finite element analysis simulation 421 for workpiece 203 using mesh model 420 and finite element analysis program 400 to obtain finite element analysis simulation results 423. Workflow manager 214 stores finite element analysis simulation results 423 from finite element analysis simulation 421 in standardized format 222 in digital thread 220. In this example, these results can be stored using JavaScript Object Notation (JSON) 302 in formats 300 for standardized format 222.

In another example, workflow manager 214 creates numeric control program 217 using computer-aided manufacturing system 402. Workflow manager 214 creates numeric control program 217 for numeric control machine 215 using product manufacturing information 234 and geometry 235 in standardized computer-aided design model 226. As an example, this information that is needed to generate numeric program 217 sent to computer-aided manufacturing system 402. The system operates to generate numeric control program 217 for use by numeric control machine 215. In this example, the program can be in the format used by numeric control machine 215 or can be sent back to workflow manager 214 to store in digital thread 220 in standardized format 222, which can then be placed into a format used by numeric control machine 215.

Further, workflow manager 214 performs manufacturing simulation 424 of workpiece 203 using machining simulation system 403. In this example, machining simulation system 403 performs manufacturing simulation 424 using the numeric control program 217 for numeric control machine 215 to obtain manufacturing simulation results 425. These simulation results can include at least one of detecting collisions between tools, validation of tool paths, determining cycle times, or other information.

In another illustrative example, manufacturing simulation 424 can be performed by computer-aided manufacturing system 402. In other illustrative examples, the simulation can be performed by different computer-aided manufacturing systems or by a specific manufacturing simulation program.

Manufacturing simulation 424 simulates the operations performed by numeric control machine 215 in manufacturing workpiece 203. For example, if numeric control machine 215 is a lathe, manufacturing simulation 424 simulates the removal of materials by the lathe. In this illustrative example, workflow manager 214 stores manufacturing simulation results 425 from manufacturing simulation 424 in standardized format 222 in digital thread 220.

These results can include any errors or issues occurring during the simulation in addition to the resulting workpiece. Further, if materials are removed, then the amount of material removed can also be in manufacturing simulation results 425 along with other information such as time needed to manufacture workpiece 203, tool wear, material use, and other information.

Additionally, workflow manager 214 sends numeric control program 217 in numeric control machine format 233 utilized by numeric control machine 215 as an input to numeric control machine 215. In one illustrative example, numeric control program 217 stored is standardized. Standardized format 222 is converted into numeric control machine format 233.

In another illustrative example, workflow manager 214 can use computer-aided manufacturing system 402 to create numeric control program 217 in numeric control machine format 233 and send that program to numeric control machine 215. With this example, the program can also be stored in digital thread 220 in standardized format 222.

Workflow manager 214 initiates manufacturing of workpiece 203 by numeric control machine 215 using numeric control program 217. With this example, workflow manager 214 receives manufacturing results 426 from numeric control machine 215 and stores manufacturing results 426 in standardized format 222 in digital thread 220. Manufacturing results 426 includes data which can be generated by sensors in or used with numeric control machine 215. These manufacturing results can include, for example, trace data, accelerometer measurements, temperature, and other information. The storage of manufacturing results 426 in standardized format 222 can be used for analysis at a later time.

In one illustrative example, workflow manager 214 creates computer-aided design model 450 in computer-aided manufacturing format 451 utilized by computer-aided manufacturing system 402 using standardized computer-aided design model 226. Workflow manager 214 sends this model to computer-aided manufacturing system 402.

Next, workflow manager 214 creates a computer-aided manufacturing model 452 in computer-aided manufacturing system 402 using product manufacturing information 234 and geometry 235 in computer-aided design model 450 in computer-aided manufacturing format 451.

Next, workflow manager 214 creates numeric control program 217 in numeric control machine format 233 utilized by numeric control machine 215 using product manufacturing information 234 and geometry 235 in computer-aided manufacturing model 452. In this illustrative example, product manufacturing information 234 and geometry 235 in computer-aided manufacturing model 452 is obtained from computer-aided design model 450 sent to computer-aided manufacturing system 402 by workflow manager 214.

In this example, workflow manager 214 receives computer-aided manufacturing model 452 from computer-aided manufacturing system 402. In response to receiving the model, workflow manager 214 stores computer-aided manufacturing model 452 with product manufacturing information 234 and geometry 235 in standardized format 222 in digital thread 220.

Workflow manager 214 can also provide interface to machine learning model system 460. Machine learning model system 460 comprises a number of machine learning models 461. The number of machine learning models 461 can be used to form optimizations for models such as standardized computer-aided design model 226 and computer-aided manufacturing model 452. Additionally, the number of machine learning models 461 in machine learning model system 460 can be used to optimize program code such as numeric control program 217.

In one illustrative example, machine learning model system 460 can be configured to optimize numeric control program 217 for numeric control machine 215. For example, a number of machine learning models 461 in machine learning model system 460 is trained to optimize numeric control program 217 for manufacturing workpiece 203. For example, the system can be trained using a training dataset comprising manufacturing simulation results 425 and manufacturing results 426. Other information in the training dataset can also include at least one of prior numeric control programs, paths, and other information associated with these results in the training dataset.

In creating numeric control program 217 in numeric control machine format 233, workflow manager 214 creates numeric control program 217 in numeric control machine format 233 utilized by numeric control machine 215 using standardized computer-aided design model 226. Workflow manager 214 optimizes numeric control program 217 using machine learning model system 460.

The illustration of manufacturing environment 200 and the different components in FIGS. 2-4 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, workflow manager 214 can also be used to manage workflows for other numeric control machines in addition to or in place of numeric control machine 215. In yet other illustrative examples, workflow manager 214 can be distributed in different computing devices within computer system 212. In other words, workflow manager 214 can be comprised of distributed components.

In yet another illustrative example, other types of systems can provide interoperability access to information in digital thread 220. For example, workflow manager 214 can provide information 221 for other analysis. For example, simulation of aging and wear can be performed for workpiece 203 using a lifecycle simulator system.

As another example, a sensor system can be present in numeric control machine 215 or used with numeric control machine 215 to collect information about the manufacturing of workpiece 203. This type of sensor system can generate data such as manufacturing results 426 in FIG. 4.

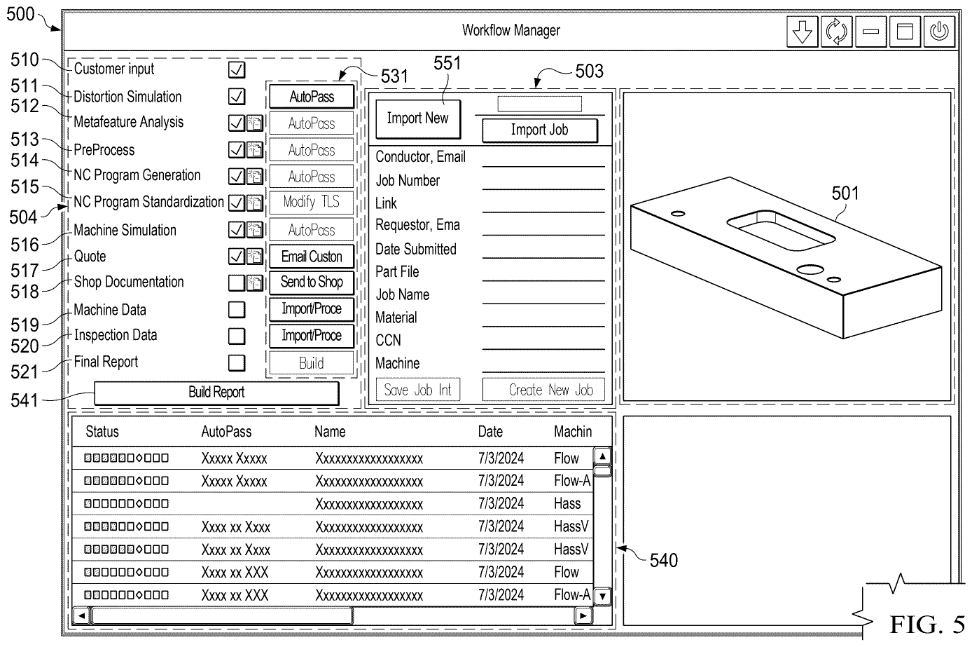

With reference next to FIG. 5, an illustration of a graphical user interface for manufacturing parts is depicted in accordance with an illustrative embodiment. In this illustrative example, window 500 is an example of a component that can be displayed in graphical user interface 273 on display system 271 in human machine interface 270 in FIG. 2.

As depicted, window 500 can be displayed to an operator enabling the operator to initiate a workflow to manufacture aluminum part 501 as displayed in window 500.

In this illustrative example, workflow for a new job can be started by selecting Import New 551 in area 503 in window 500. Selection of this control can be used to import a job that has been previously defined to create a new job. In this example, information for a job can be displayed in area 503 to window 500. If an existing job is not present for use to manufacture aluminum part 501, information about the job can be entered directly into area 503 in window 500 by the operator to create a new job.

In this illustrative example, tasks to be performed in the workflow for the job are displayed in area 504 in window 500. The tasks performed depend on the particular job. For example, tasks to manufacture a workpiece in the form of an aluminum part are different from the tasks performed for manufacturing a workpiece in the form of a ply stack. In this example, the tasks displayed in area 504 are for manufacturing aluminum part 501 as displayed in area 504 of window 500.

In this illustrative example, the tasks in area 504 to manufacture aluminum part 501 comprise Customer Input 510, Distortion Simulation 511, Metafeature Analysis 512, PreProcess 513, NC Program Generation 514, NC Program Standardization 515, Machine Simulation 516, Quote 517, Shop Documentation 518, Machine Data 519, Inspection Data 520, and Final Report 521.

In this illustrative example, area 504 indicates a status of tasks in the current job. Section 531 in area 504 contains controls that can be selected by the operator to initiate each task as needed. In some cases, the process is automated such that user input is not needed to initiate every task and in some examples, only user input selecting a job is needed to initiate automatic performance of the tasks in the workflow for the job.

In this example, area 540 depicts status information for different tasks. The status information can be for the current job being initiated in window 500. The status information can also include tasks being performed for other jobs that are currently being processed.

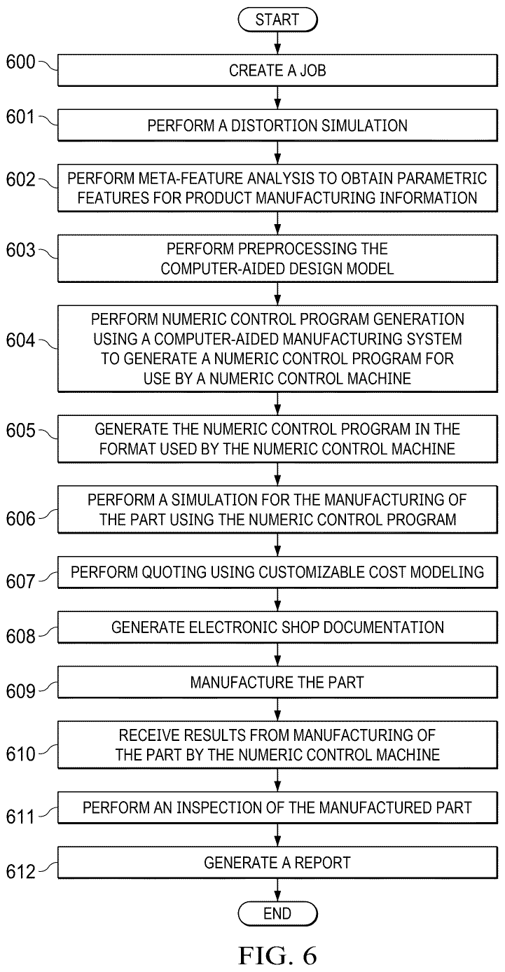

With reference next to FIG. 6, an illustration of a process flow for performing tasks to manufacture an aluminum part is depicted in accordance with an illustrative embodiment. In this illustrative example, the process flow illustrates the operations used to perform tasks for manufacturing aluminum part 501 illustrated in area 504 in window 500 in FIG. 5. This process can be performed using workflow manager 214 and window 500.

In this example, the process begins by creating a job (operation 600). In this example, operation 600 is used in the task labeled as Customer Input 510 in FIG. 5.

In operation 600, a computer-aided design (CAD) file for aluminum part 501 has been selected for manufacturing. The process opens this CAD file as part of creating the job. Operation 600 also involves generating a standardized computer-aided design file from the computer-aided design file for aluminum part 501 in a standardized format in which this file is stored in the digital thread.

Further, the job creation also includes assigning an NC machine for manufacturing aluminum part 501. Other information for the job including requester, part file, job name, material, and other information can be imported from a job template for aluminum part 501 and displayed in area 503 in window 500. Alternatively, information for this job can be entered into area 503.

The process then performs a distortion simulation (operation 601). This is an example of how Distortion Simulation 511 in FIG. 5 can be performed.

In this operation, a mesh model is created for a finite element analysis for aluminum part 501. Operation 601 also includes setting simulation parameters and sending these parameters and the mesh model to the finite element analysis program and then initiating the analysis using these inputs.

In this operation, the distortion simulation is a type of finite element analysis that can predict and analyze the formations for distortions and a material under various conditions. This simulation can determine how factors such as thermal loads, mechanical stresses, or manufacturing processes can cause changes in the shape or geometry of a part. The simulation can be used to determine whether desired dimensional accuracy, structural integrity, and functionality of manufactured parts will occur. This information can be used to determine the optimal positioning of the parts within a stock or blank.

This operation also includes receiving results from the finite element analysis program, placing these results in a standardized format, and then storing the results in the digital thread. In this example, the mesh model is also stored in a standardized format in the digital thread.

Next, the process performs meta-feature analysis to obtain parametric features for product manufacturing information (operation 602). This operation is an example of how Metafeature Analysis 512 in FIG. 5 can be performed.

This operation involves using a computer-aided design system to generate the parametric features. As part of this process, a computer-aided design model is created from a standardized computer-aided design model in which this model has a format used by the computer-aided design systems selected for generating the parametric features.

The computer-aided design model is opened in the computer-aided design system. The process sends commands and requests to the computer-aided design system to obtain parametric features for this model of aluminum part 501. In this example, the computer-aided design model system outputs the parametric features in response to requests from the workflow manager. These parametric features are then placed into a standardized format within the standardized computer-aided design model. These features can also be stored in a standardized format separately from the standardized computer-aided design model in the digital thread.

In some instances, the parametric features are already present in the standardized computer-aided design model. In this case, this operation is unnecessary.

The process performs preprocessing the computer-aided design model (operation 603). This operation is an example of an implementation for performing PreProcess 513 in FIG. 5.

In this operation, the computer-aided design model generated from the computer-aided design model selected for aluminum part 501 may be translated into a Standard for the Exchange of Product model data format and may not be fully standardized for the standardized computer-aided design model. Translating the computer-aided design model into a Standard for the Exchange of Product model data format results in information that is standardized to some extent.

However, variability can still be present with respect to what information is located in particular layers and the naming of layers. Although the information is described using standardized schema, the same information may be stored in different layers in different files. For example, one organization may store dimension information in layer 10, while another organization may store dimension information in layer 3.

In this illustrative example, this CAD file using the Standard for the Exchange of Product model data schema is standardized such that the same information is always stored in the same layers for all of the computer-aided design files used by the workflow manager in the list of examples. Thus, the result of this operation is the standardized curated design model for aluminum part 501. In other words, the computer-aided design model is not merely formed by translation of the original computer-aided design file into a Standard for the Exchange of Product model data format but also includes standardizing where information is stored and naming conventions for that information as well as other types of standardization.

The process performs numeric control program generation using a computer-aided manufacturing system to generate a numeric control program for use by a numeric control machine (operation 604). This operation is an example of how NC Program Generation 514 in FIG. 5 can be performed.

In one illustrative example, the process translates the standardized computer-aided design model into a computer-aided design model that uses a format employed by the computer-aided manufacturing system to import computer-aided design models. This computer-aided design model is sent to the computer-aided manufacturing system, which generates the computer-aided manufacturing design from that model. Further, other information needed to generate the numeric control program is also sent to the computer-aided manufacturing system. This information can include, for example, dynamic initialization (INI) files for machine and workholding specific settings, tool information, cutting parameters, dynamic process templates with set up information, toolpath and other information.

Additionally in operation 604, the process uses this information sent to the computer-aided manufacturing system to generate the numeric control program. The process creates the numeric control program using the information and the computer-aided manufacturing model. The computer-aided manufacturing model is saved in the standardized format in the digital thread.

The process generates the numeric control program in the format used by the numeric control machine (operation 605). This operation is an example of how NC Program Standardization 515 in FIG. 5 can be performed. In this illustrative example, the numeric control program received from the computer-aided manufacturing system may be in a generic format. This generic tool format can be, for example, Center Line Source File (CLSF) or APT (Automatically Programmed Tools) language and can be used to convert the numeric control program in the generic format to a specific G-code and M-code for each particular numeric control machine that will manufacture aluminum part 501. In this example, G-code specifies motion related instructions such as positioning, paths, feed rates. M-Code specifies non-motion operations such as spindle control, tool changes, and other types of operations.

The process then performs a simulation for the manufacturing of the part using the numeric control program (operation 606). Operation 606 is an example of Machine Simulation 516 in FIG. 5.

In this example, the numeric control program is set to a machining simulation system that simulates the machining of stock or other type of material to form aluminum part 501. The results of the simulation are returned in a report and can include analysis of tools use, errors, materials used, cycle time, and other information. This information is stored in a standardized format in the digital thread.

Next, the process performs quoting using customizable cost modeling (operation 607). Operation 607 is an example of how Quote 517 in FIG. 5 can be performed.

In this example, quoting is performed using a customizable cost modeling using information obtained in the manufacturing simulation of the machining performed to manufacture aluminum part 501 in operation 607. In addition to the results from the manufacturing simulation, this quoting can also include taking into account customer costs, numeric control machine type, and other customer data. For example, one numeric control machine may be more complex having a higher cost as compared to a simpler numeric control machine. Further, the types of tools used, manufacturing rates for a particular type of numeric control machine, and other information can affect the quotes for manufacturing aluminum part 501.

The process also generates electronic shop documentation (operation 608). This operation is an example of how the task Shop Documentation 518 in FIG. 5 can be performed.

The electronic shop documents can be generated using manufacturing simulation results from the simulation performed in operation 606. The electronic shop documentation can include information such as part drawings with dimensions, tolerances, and surface finishes. This information can include setup instructions. The electronic shop documentation may also provide tooling information such as tool types, dimensions, and offsets. Other information in the electronic shop documents can be machining parameters such as feed rates, spindle speeds, and cutting depths. This and other information that may be used by an operator to perform setups needed for the numeric control machine to manufacture aluminum part 501 can be included in the electronic shop documents.

The process manufactures the part (operation 609). In this operation, manufacturing of the part can be initiated through a message sent to at least one of the numeric control machine or the operator.

The process receives results from manufacturing of the part by the numeric control machine (operation 610). Operation 610 is an example of an operation for performing Machine Data 519 in FIG. 5.

In this operation, results from manufacturing the part are received from the numeric control machine. This information can be for example, trace data, accelerometer measurements, temperature, and other information that can be detected by sensors or generated by the numeric control machine from manufacturing aluminum part 501. These results are in a standardized format in the digital thread. This information can be analyzed at a later time. Further, this information can also be used for training the machine learning model to optimize numeric control programs for manufacturing parts.

The process then performs an inspection of the manufactured part (operation 611). Operation 611 is an example of how inspection data 520 in FIG. 5 can be captured.

In this operation, the process initiates or performs an inspection of aluminum part 501 using an inspection system such as a coordinate measurement system. The process receives inspection results from the inspection system. This operation also stores the results in a standardized format in the digital thread. For example, the inspection results may be received as a spreadsheet or a portable document format (PDF) file. This information can be translated into JavaScript Object Notation objects and stored as product manufacturing information in the digital thread.

The process generates a report (operation 612). The process terminates thereafter. This operation is an example of how Final Report 521 in FIG. 5 can be performed.

The process in this operation organizes information in the digital thread into a report for viewing the human machine interface. This report can include, for example, lighting charts, graphs, plots, and other information. In this example, the report creation for Final Report 521 in FIG. 5 can be initiated by selecting the control Build Report 541 in FIG. 5.

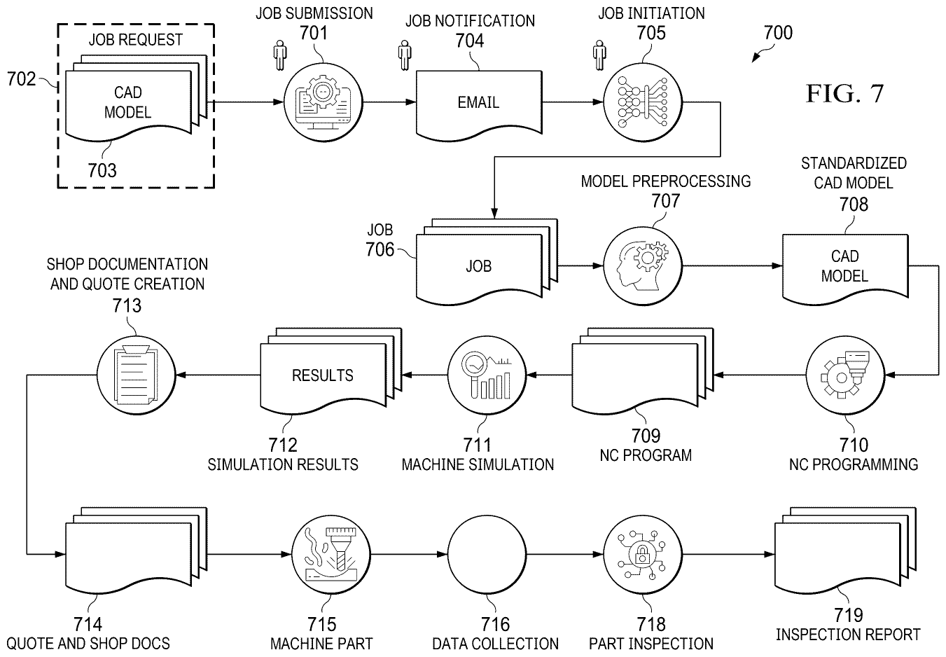

Next in FIG. 7, an illustration of a process flow for manufacturing a physical machine part is depicted in accordance with an illustrative embodiment. In this example, process flow 700 can be used to generate workpiece 203 in FIG. 2 and in particular to a physical machined part such as aluminum part 501 in FIG. 5. This process can be performed using workflow manager 214 in manufacturing system 202 in FIG. 2.

In process flow 700, the information generated as part of this process flow is in a standardized format and stored in a digital thread. Further, other information such as models that are selected for use or job information from other sources can be saved in the standardized format in the digital thread.

In this example, process flow 700 begins with Job Submission 701 in which job request 702 in the form of CAD model 703 is received. In response to receiving job request 702 in Jobs Submission 701, Job Notification 704 is a computer-generated email sent to an operator such as a job conductor. In this example, this email includes a reference to a job number.

Next, Job Initiation 705 occurs in which initiation of the job is made using the information in the email sent as part of Job Notification 704. In this example, Job Initiation 705 includes using the reference to the job number in the email. Job Initiation 705 can be performed with user input to a graphical user interface for a website. For example, Job Initiation 705 can be performed using window 500 in FIG. 5.

Next, results of Job Initiation 705, is job 706 in a standardized format that is saved in a digital thread. This information in job 706 can be saved in using JavaScript Object Notation objects. This job is used to perform various tasks in process flow 700.

After saving Job 706, Model Preprocessing 707 involves metafeature analysis. Information, such as parametric features describing the part, any obtained this metafeature analysis. In this illustrated example, this information is placed into CAD model 703.

CAD model 703 may be in a Standard for the Exchange of Product model data format but has not been fully processed to be in a standardized format for saving in the digital thread and use in process flow 700. In this case, further processing of this CAD model is performed such that the location of data in different structures and the labeling or annotation of the data in the model is in a standardized format to form standardized CAD model 708.

Next, NC program 709 is generated in NC Programming 710 using standardized CAD model 708. In this example, NC programming 710 can be performed using a computer-aided manufacturing system that is generated by a computer-aided manufacturing model from standardized CAD model 708.

Machine Simulation 711 is performed using NC program 709. The simulation is an example of manufacturing simulation 424 in FIG. 4. Simulation results 712 resulting from machine simulation 711 are stored in a standardized format in the digital thread. These results are used in Shop Documentation and Quote Creation 713 to create quote and shop docs 714.

Next, Machine Part 715 involves performing machining of stock, blank, or other material to form the parts. Next, Data Collection 716 occurs in which data detected during Machine Part 715 is obtained and stored in a standardized format in the digital thread.

Part Inspection 718 occurs in which the machine part is inspected using an inspection system to determine whether the machine part meets tolerances defined for the parts. This inspection system can be a coordinate measurement system (CMM) and or other suitable type of inspection system. The result of this task is inspection report 719, which is saved in a standardized format in the digital thread.

The illustration of process flow 700 is an example of the process flow that can be implemented using workflow manager 214 in FIG. 2. This example is not meant to limit the manner in which other process flows can be implemented.

For example, depending on the level of automation for the numeric control machine, the creation of shop documentation may be omitted. In another illustrative example, user input may be integrated within process flow 700 to confirm or halt the performance of different tasks in process flow 700.

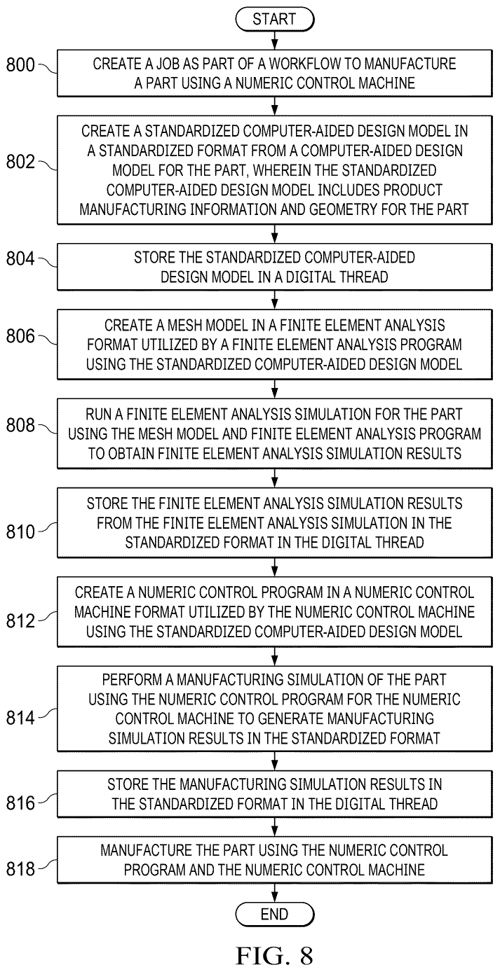

Turning next to FIG. 8, an illustration of a flowchart of a process for manufacturing a part is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in workflow manager 214 in computer system 212 in FIG. 2.

The process begins by creating a job as part of a workflow to manufacture a part using a numeric control machine (operation 800). The process creates a standardized computer-aided design model in a standardized format from a computer-aided design model for the part, wherein the standardized computer-aided design model includes product manufacturing information and geometry for the part (operation 802). The process stores the standardized computer-aided design model in a digital thread (operation 804).

The process creates a mesh model in a finite element analysis format utilized by a finite element analysis program using the standardized computer-aided design model (operation 806). The process runs a finite element analysis simulation for the part using the mesh model and finite element analysis program to obtain finite element analysis simulation results (operation 808). The process stores the finite element analysis simulation results from the finite element analysis simulation in the standardized format in the digital thread (operation 810).

The process creates a numeric control program in a numeric control machine format utilized by the numeric control machine using the standardized computer-aided design model (operation 812). The process performs a manufacturing simulation of the part using the numeric control program for the numeric control machine to generate manufacturing simulation results in the standardized format (operation 814). The process stores the manufacturing simulation results in the standardized format in the digital thread (operation 816).

The process manufactures the part using the numeric control program and the numeric control machine (operation 818). The process terminates thereafter. In operation 818, the manufacturing can be performed by the workflow manager sending a notification or instructions to manufacture the part using the numeric control program. Depending on the level of automation, the workflow manager can control the numeric control machine, robotic systems, and other equipment to manufacture the part.

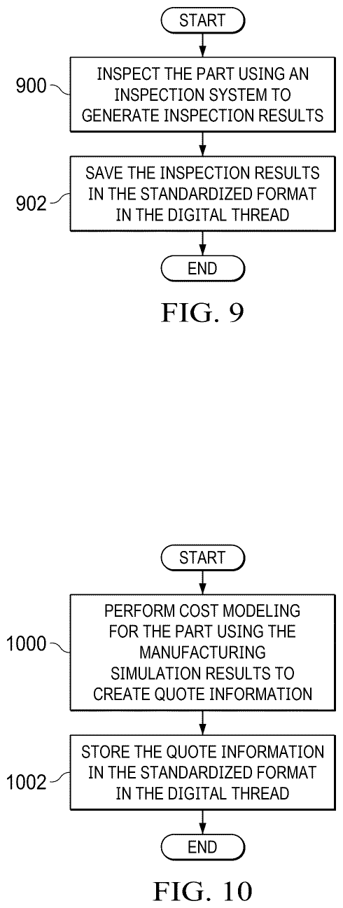

With reference next to FIG. 9, an illustration of a flowchart of a process for inspecting a part is depicted in accordance with an illustrative embodiment. The process of this flowchart is an example of additional operations that can be performed with the operations of FIG. 8.

The process inspects the part using an inspection system to generate inspection results (operation 900). This inspection can be performed using various inspection systems that can generate data for the results of the part manufactured using the numeric control program.

The process saves the inspection results in the standardized format in the digital thread (operation 902). The process terminates thereafter.

In FIG. 10, an illustration of a flowchart of a process for generating a quote is depicted in accordance with an illustrative embodiment. The process of this flowchart is an example of additional operations that can be performed with the operations of FIG. 8.

The process performs cost modeling for the part using the manufacturing simulation results to create quote information (operation 1000). The process stores the quote information in the standardized format in the digital thread (operation 1002). The process terminates thereafter.

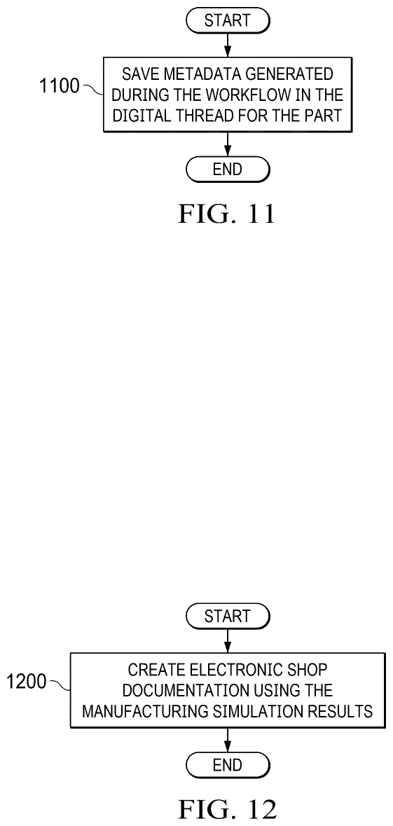

Turning to FIG. 11, an illustration of a flowchart of a process for saving metadata is depicted in accordance with an illustrative embodiment. The process of this flowchart is an example of additional operations that can be performed with the operations of FIG. 8.

The process saves metadata generated during the workflow in the digital thread for the part (operation 1100). The process terminates thereafter. In this example, metadata can be any information generated during the workflow used to manufacture a part.

Turning to FIG. 12, an illustration of a flowchart of a process for creating shop documentation is depicted in accordance with an illustrative embodiment. The process of this flowchart is an example of additional operations that can be performed with the operations of FIG. 8.

The process creates electronic shop documentation using the manufacturing simulation results (operation 1200). The process terminates thereafter.

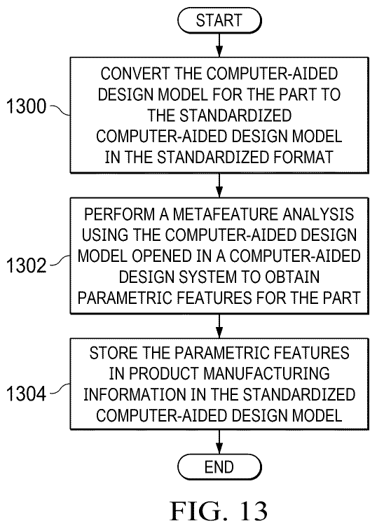

With reference next to FIG. 13, an illustration of a flowchart of a process for creating a standardized computer-aided design model is depicted in accordance with an illustrative embodiment. The process of this flowchart is an example of an implementation for operation 802 in FIG. 8.

The process converts the computer-aided design model for the part to the standardized computer-aided design model in the standardized format (operation 1300). The process performs a metafeature analysis using the computer-aided design model opened in a computer-aided design system to obtain parametric features for the part (operation 1302).

Next, the process stores the parametric features in product manufacturing information in the standardized computer-aided design model (operation 1304). The process terminates thereafter.

Thus, this process can take into account that the parametric features may not be in the computer-aided design model and can identify the parametric features using the computer-aided design model and store this information in the standardized computer-aided design model.

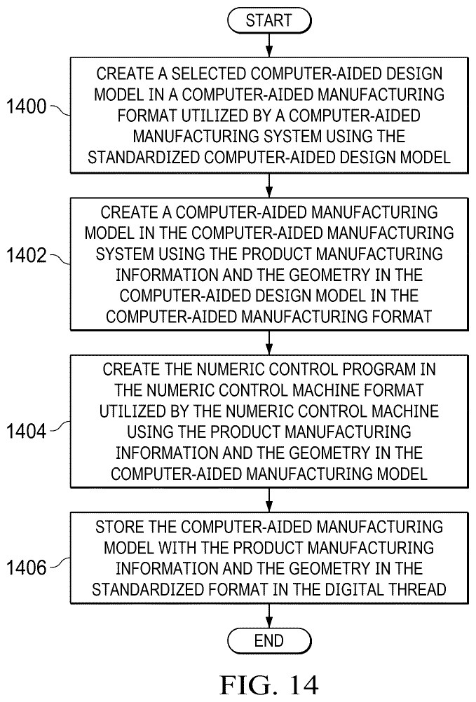

Next in FIG. 14, an illustration of a flowchart of a process for creating a numeric control program is depicted in accordance with an illustrative embodiment. The process of this flowchart is an example of an implementation for operation 812 in FIG. 8.

The process creates a selected computer-aided design model in a computer-aided manufacturing format utilized by a computer-aided manufacturing system using the standardized computer-aided design model (operation 1400). The process creates a computer-aided manufacturing model in the computer-aided manufacturing system using the product manufacturing information and the geometry in the computer-aided design model in the computer-aided manufacturing format (operation 1402).

The process creates the numeric control program in the numeric control machine format utilized by the numeric control machine using the product manufacturing information and the geometry in the computer-aided manufacturing model (operation 1404). The process stores the computer-aided manufacturing model with the product manufacturing information and the geometry in the standardized format in the digital thread (operation 1406). The process terminates thereafter.

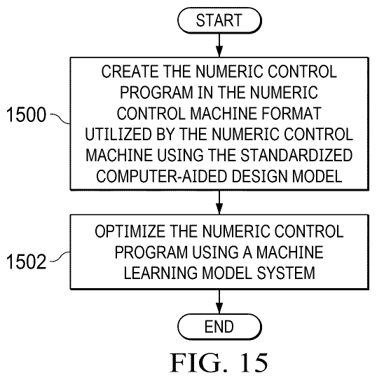

With reference now to FIG. 15, an illustration of a flowchart of a process for creating a numeric control program is depicted in accordance with an illustrative embodiment. The process of this flowchart is an example of an implementation for operation 812 in FIG. 8.

The process creates the numeric control program in the numeric control machine format utilized by the numeric control machine using the standardized computer-aided design model (operation 1500). The process optimizes the numeric control program using a machine learning model system (operation 1502). The process terminates thereafter.

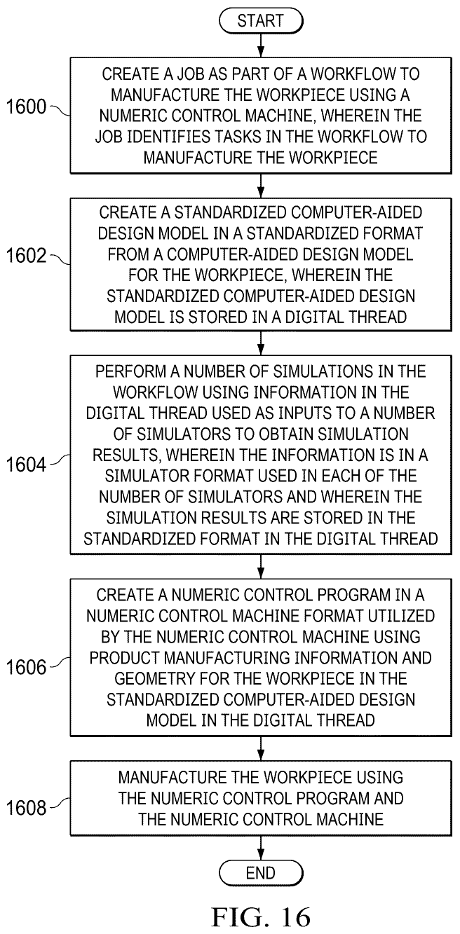

Turning next to FIG. 16, an illustration of a flowchart of a process for manufacturing a part is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in workflow manager 214 in computer system 212 in FIG. 2.

The process begins by creating a job as part of a workflow to manufacture the workpiece using a numeric control machine, wherein the job identifies tasks in the workflow to manufacture the workpiece (operation 1600). The process creates a standardized computer-aided design model in a standardized format from a computer-aided design model for the workpiece, wherein the standardized computer-aided design model is stored in a digital thread (operation 1602).

The process performs a number of simulations in the workflow using information in the digital thread used as inputs to a number of simulators to obtain simulation results, wherein the information is in a simulator format used in each of the number of simulators and wherein the simulation results are stored in the standardized format in the digital thread (operation 1604). The process creates a numeric control program in a numeric control machine format utilized by the numeric control machine using product manufacturing information and geometry for the workpiece in the standardized computer-aided design model in the digital thread (operation 1606).

The process manufactures the workpiece using the numeric control program and the numeric control machine (operation 1608). The process terminates thereafter.

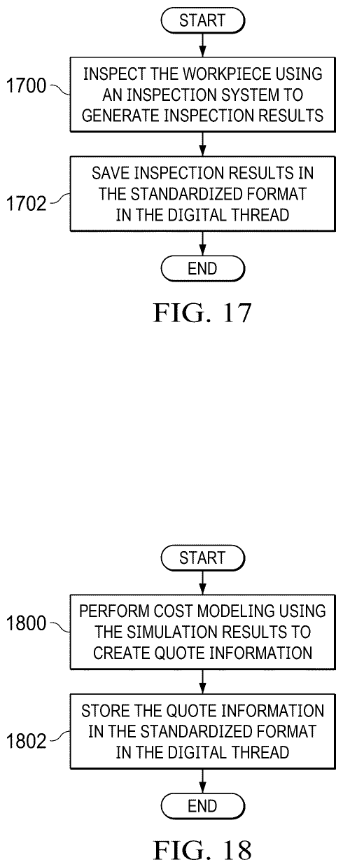

Next in FIG. 17, an illustration of a flowchart of a process for inspecting a workpiece is depicted in accordance with an illustrative embodiment. The process in this flowchart is an example of additional operations that can be performed with the operations in FIG. 15.

The process inspects the workpiece using an inspection system to generate inspection results (operation 1700). The process saves inspection results in the standardized format in the digital thread (operation 1702). The process terminates thereafter.

Turning now to FIG. 18, an illustration of a flowchart of a process for creating quote information is depicted in accordance with an illustrative embodiment. The process in this flowchart is an example of additional operations that can be performed with the operations in FIG. 15.

The process performs cost modeling using the simulation results to create quote information (operation 1800). The process stores the quote information in the standardized format in the digital thread (operation 1802). The process terminates thereafter.

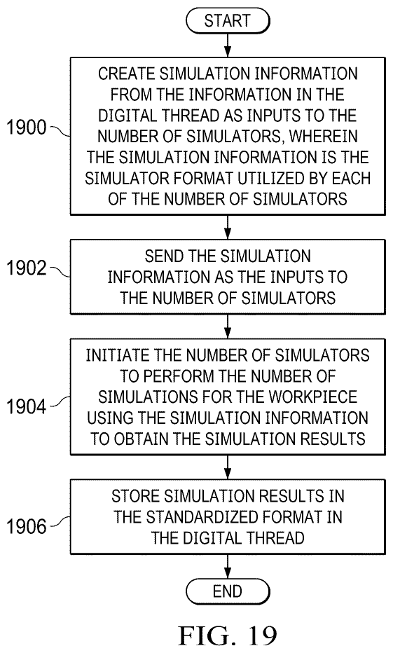

Next in FIG. 19, an illustration of a flowchart of a process for performing a number of simulations in a workflow is depicted in accordance with an illustrative embodiment. The process in this flowchart is an example of an implementation for operation 1604 in FIG. 15.

The process begins by creating simulation information from the information in the digital thread as inputs to the number of simulators, wherein the simulation information is the simulator format utilized by each of the number of simulators (operation 1900). The process sends the simulation information as the inputs to the number of simulators (operation 1902).

The process initiates the number of simulators to perform the number of simulations for the workpiece using the simulation information to obtain the simulation results (operation 1904). The process stores simulation results in the standardized format in the digital thread (operation 1906). The process terminates thereafter.

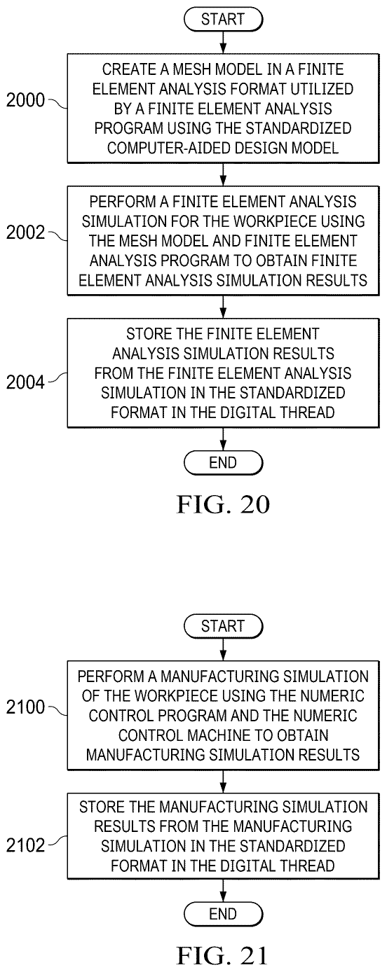

Referring now to FIG. 20, an illustration of a flowchart of a process for performing a number of simulations in a workflow is depicted in accordance with an illustrative embodiment. The process in this flowchart is an example of an implementation for operation 1604 in FIG. 15.

The process creates a mesh model in a finite element analysis format utilized by a finite element analysis program using the standardized computer-aided design model (operation 2000). The process performs a finite element analysis simulation for the workpiece using the mesh model and finite element analysis program to obtain finite element analysis simulation results (operation 2002).

The process stores the finite element analysis simulation results from the finite element analysis simulation in the standardized format in the digital thread (operation 2004). The process terminates thereafter.

With reference next to FIG. 21, an illustration of a flowchart of a process for performing a number of simulations in a workflow is depicted in accordance with an illustrative embodiment. The process in this flowchart is an example of an implementation for operation 1604 in FIG. 15.

The process performs a manufacturing simulation of the workpiece using the numeric control program and the numeric control machine to obtain manufacturing simulation results (operation 2100).

The process stores the manufacturing simulation results from the manufacturing simulation in the standardized format in the digital thread (operation 2102). The process terminates thereafter.

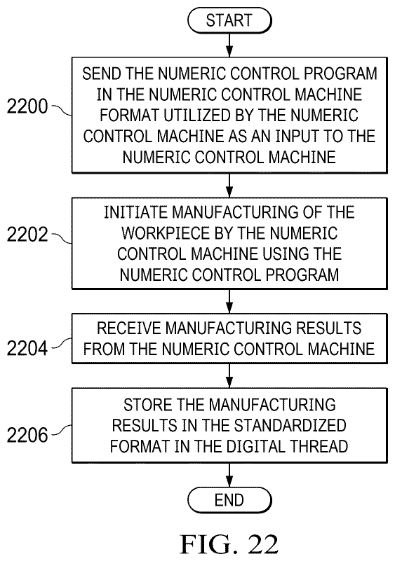

In FIG. 22, an illustration of a flowchart of a process for manufacturing a workpiece is depicted in accordance with an illustrative embodiment. The process in this flowchart is an example of an implementation for operation 1608 in FIG. 15.

The process sends the numeric control program in the numeric control machine format utilized by the numeric control machine as an input to the numeric control machine (operation 2200). The process initiates manufacturing of the workpiece by the numeric control machine using the numeric control program (operation 2202).

The process receives manufacturing results from the numeric control machine (operation 2204). The process stores the manufacturing results in the standardized format in the digital thread (operation 2206). The process terminates thereafter.

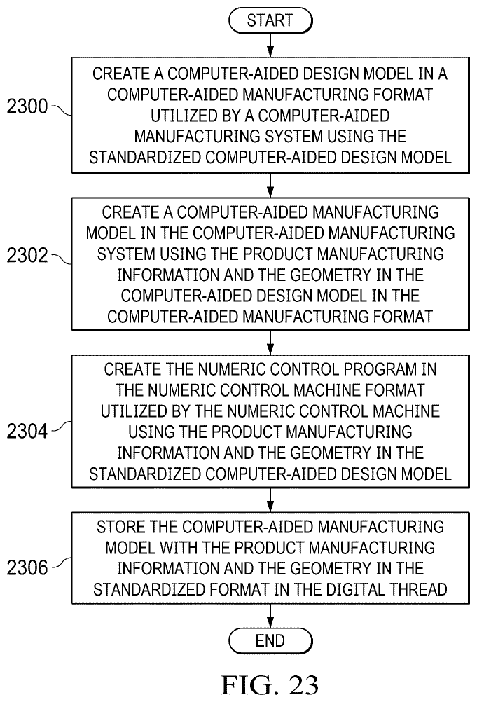

With reference to FIG. 23, an illustration of a flowchart of a process for creating a numeric control program is depicted in accordance with an illustrative embodiment. The process in this flowchart is an example of an implementation for operation 1606 in FIG. 15.

The process begins by creating a computer-aided design model in a computer-aided manufacturing format utilized by a computer-aided manufacturing system using the standardized computer-aided design model (operation 2300). The process creates a computer-aided manufacturing model in the computer-aided manufacturing system using the product manufacturing information and the geometry in the computer-aided design model in the computer-aided manufacturing format (operation 2302).

The process creates the numeric control program in the numeric control machine format utilized by the numeric control machine using the product manufacturing information and the geometry in the standardized computer-aided design model (operation 2304). The process stores the computer-aided manufacturing model with the product manufacturing information and the geometry in the standardized format in the digital thread (operation 2306). The process terminates thereafter.

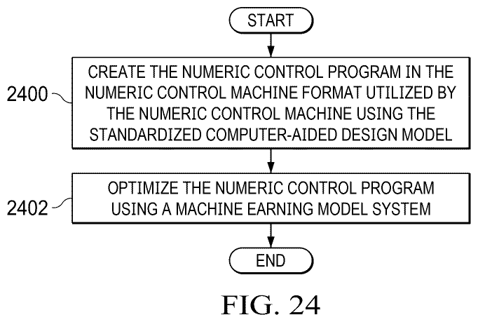

In FIG. 24, an illustration of a flowchart of a process for creating a numeric control program is depicted in accordance with an illustrative embodiment. The process in this flowchart is example of an implementation for operation 1606 in FIG. 15.

The process creates the numeric control program in the numeric control machine format utilized by the numeric control machine using the standardized computer-aided design model (operation 2400). The process optimizes the numeric control program using a machine learning model system (operation 2402). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

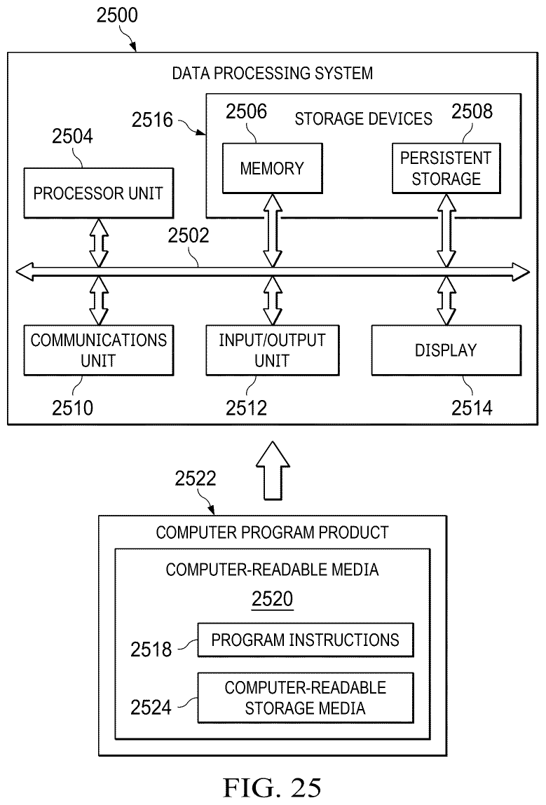

Turning now to FIG. 25, a block diagram of a data processing system is depicted in accordance with an illustrative embodiment. Data processing system 2500 can be used to implement server computer 104, server computer 106, client devices 110, in FIG. 1. Data processing system 2500 can also be used to implement computer system 212 in FIG. 2. In this illustrative example, data processing system 2500 includes communications framework 2502, which provides communications between processor unit 2504, memory 2506, persistent storage 2508, communications unit 2510, input/output (I/O) unit 2512, and display 2514. In this example, communications framework 2502 takes the form of a bus system.

Processor unit 2504 serves to execute instructions for software that can be loaded into memory 2506. Processor unit 2504 includes one or more processors. For example, processor unit 2504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 2504 can be implemented using one or more heterogeneous processor systems in which a main processor is present with secondary processors on a single chip. As another illustrative example, processor unit 2504 can be a symmetric multi-processor system containing multiple processors of the same type on a single chip.

Memory 2506 and persistent storage 2508 are examples of storage devices 2516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 2516 may also be referred to as computer-readable storage devices in these illustrative examples. Memory 2506, in these examples, can be, for example, a random-access memory or any other suitable volatile or non-volatile storage device. Persistent storage 2508 may take various forms, depending on the particular implementation.

For example, persistent storage 2508 may contain one or more components or devices. For example, persistent storage 2508 can be a hard drive, a solid-state drive (SSD), a flash memory, a rewritable optical disk, a rewritable magnetic tape, or some combination of the above. The media used by persistent storage 2508 also can be removable. For example, a removable hard drive can be used for persistent storage 2508.

Communications unit 2510, in these illustrative examples, provides for communications with other data processing systems or devices. In these illustrative examples, communications unit 2510 is a network interface card.

Input/output unit 2512 allows for input and output of data with other devices that can be connected to data processing system 2500. For example, input/output unit 2512 may provide a connection for user input through at least one of a keyboard, a mouse, or some other suitable input device. Further, input/output unit 2512 may send output to a printer. Display 2514 provides a mechanism to display information to a user.

Instructions for at least one of the operating system, applications, or programs can be located in storage devices 2516, which are in communication with processor unit 2504 through communications framework 2502. The processes of the different embodiments can be performed by processor unit 2504 using computer-implemented instructions, which may be located in a memory, such as memory 2506.

These instructions are referred to as program instructions, computer usable program instructions, or computer-readable program instructions that can be read and executed by a processor in processor unit 2504. The program instructions in the different embodiments can be embodied on different physical or computer-readable storage media, such as memory 2506 or persistent storage 2508.

Program instructions 2518 are located in a functional form on computer-readable media 2520 that is selectively removable and can be loaded onto or transferred to data processing system 2500 for execution by processor unit 2504. Program instructions 2518 and computer-readable media 2520 form computer program product 2522 in these illustrative examples. In the illustrative example, computer-readable media 2520 is computer-readable storage media 2524.

Computer-readable storage media 2524 is a physical or tangible storage device used to store program instructions 2518 rather than a medium that propagates or transmits program instructions 2518. Computer-readable storage media 2524 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 2524, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 2518 can be transferred to data processing system 2500 using a computer-readable signal media. The computer-readable signal media are signals and can be, for example, a propagated data signal containing program instructions 2518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 2520” can be singular or plural. For example, program instructions 2518 can be located in computer-readable media 2520 in the form of a single storage device or system. In another example, program instructions 2518 can be located in computer-readable media 2520 that is distributed in multiple data processing systems. In other words, some instructions in program instructions 2518 can be located in one data processing system while other instructions in program instructions 2518 can be located in one data processing system. For example, a portion of program instructions 2518 can be located in computer-readable media 2520 in a server computer while another portion of program instructions 2518 can be located in computer-readable media 2520 located in a set of client computers.

The different components illustrated for data processing system 2500 are not meant to provide architectural limitations to the manner in which different embodiments can be implemented. In some illustrative examples, one or more of the components may be incorporated in or otherwise form a portion of, another component. For example, memory 2506, or portions thereof, may be incorporated in processor unit 2504 in some illustrative examples. The different illustrative embodiments can be implemented in a data processing system including components in addition to or in place of those illustrated for data processing system 2500. Other components shown in FIG. 25 can be varied from the illustrative examples shown. The different embodiments can be implemented using any hardware device or system capable of running program instructions 2518.

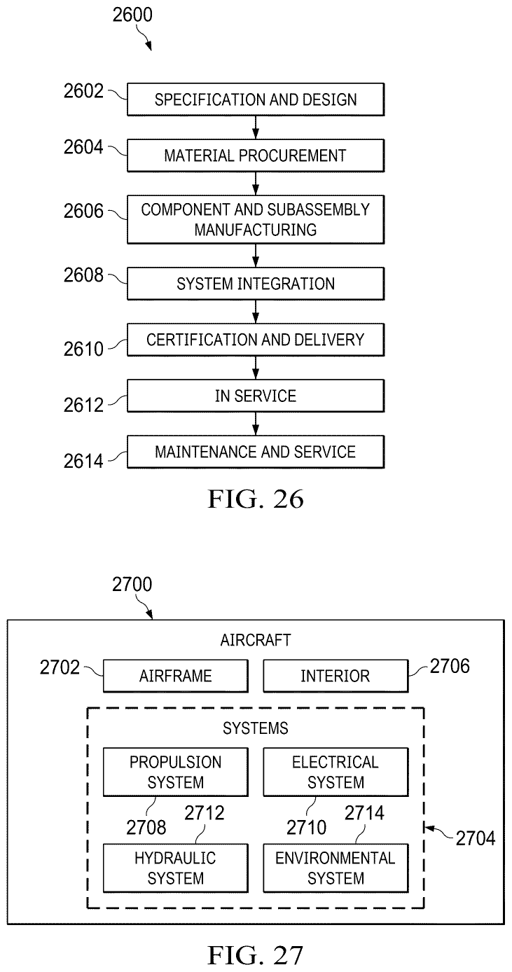

Illustrative embodiments of the disclosure may be described in the context of aircraft manufacturing and service method 2600 as shown in FIG. 26 and aircraft 2700 as shown in FIG. 27. Turning first to FIG. 26, an illustration of an aircraft manufacturing and service method is depicted in accordance with an illustrative embodiment. During pre-production, aircraft manufacturing and service method 2600 may include specification and design 2602 of aircraft 2700 in FIG. 27 and material procurement 2604.

During production, component and subassembly manufacturing 2606 and system integration 2608 of aircraft 2700 in FIG. 27 takes place. Thereafter, aircraft 2700 in FIG. 27 can go through certification and delivery 2610 in order to be placed in service 2612. While in service 2612 by a customer, aircraft 2700 in FIG. 27 is scheduled for routine maintenance and service 2614, which may include modification, reconfiguration, refurbishment, and other maintenance or service.

Each of the processes of aircraft manufacturing and service method 2600 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 27, an illustration of an aircraft is depicted in which an illustrative embodiment may be implemented. In this example, aircraft 2700 is produced by aircraft manufacturing and service method 2600 in FIG. 26 and may include airframe 2702 with plurality of systems 2704 and interior 2706. Examples of systems 2704 include one or more of propulsion system 2708, electrical system 2710, hydraulic system 2712, and environmental system 2714. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 2600 in FIG. 26.

In one illustrative example, components or subassemblies produced in component and subassembly manufacturing 2606 in FIG. 26 can be fabricated or manufactured in a manner similar to components or subassemblies produced while aircraft 2700 is in service 2612 in FIG. 26. As yet another example, one or more apparatus embodiments, method embodiments, or a combination thereof can be utilized during production stages, such as component and subassembly manufacturing 2606 and system integration 2608 in FIG. 26. One or more apparatus embodiments, method embodiments, or a combination thereof may be utilized while aircraft 2700 is in service 2612, during maintenance and service 2614 in FIG. 26, or both. The use of a number of the different illustrative embodiments may substantially expedite the assembly of aircraft 2700, reduce the cost of aircraft 2700, or both expedite the assembly of aircraft 2700 and reduce the cost of aircraft 2700.

In this illustrative example, workflow manager 214 and manufacturing system 202 can be used during one or more of the different stages in manufacturing and service method 2600. For example, workflow manager 214 can be used during component and subassembly manufacturing 2606 to manufacture parts for aircraft 2700. As another example, workflow manager 214 can also be used during maintenance and service 2614 to manufacture parts for modification, reconfiguration, refurbishment, and other maintenance or service of aircraft 2700.

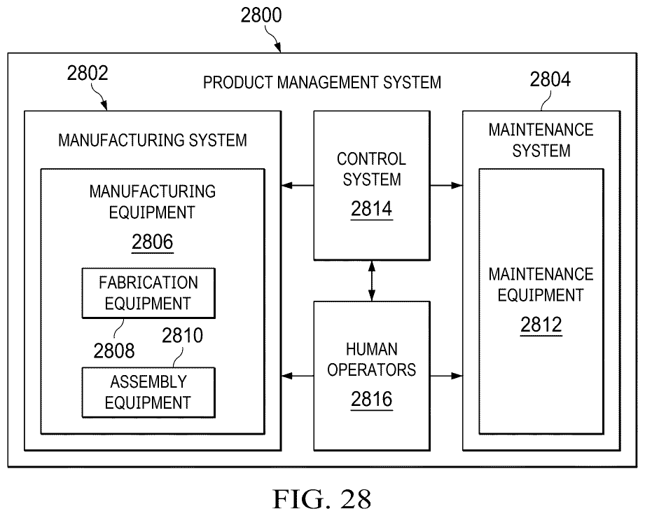

Turning now to FIG. 28, an illustration of a block diagram of a product management system is depicted in accordance with an illustrative embodiment. Product management system 2800 is a physical hardware system. In this illustrative example, product management system 2800 includes at least one of manufacturing system 2802 or maintenance system 2804.

Manufacturing system 2802 is configured to manufacture products, such as aircraft 2700 in FIG. 27. As depicted, manufacturing system 2802 includes manufacturing equipment 2806. Manufacturing equipment 2806 includes at least one of fabrication equipment 2808 or assembly equipment 2810.

Fabrication equipment 2808 is equipment that is used to fabricate components or parts used to form aircraft 2700 in FIG. 27. For example, fabrication equipment 2808 can include machines and tools. These machines and tools can be at least one of a drill, a hydraulic press, a furnace, an autoclave, a mold, a composite tape laying machine, an automated fibre placement (AFP) machine, a vacuum system, a robotic pick and place system, a flatbed cutting machine, a laser cutter, a computer numerical control (CNC) cutting machine, a lathe, or other suitable types of equipment. Fabrication equipment 2808 can be used to fabricate at least one of metal parts, composite parts, semiconductors, circuits, fasteners, ribs, skin panels, spars, antennas, or other suitable types of parts.

Assembly equipment 2810 is equipment used to assemble parts to form aircraft 2700 in FIG. 27. In particular, assembly equipment 2810 is used to assemble components and parts to form aircraft 2700 in FIG. 27. Assembly equipment 2810 also can include machines and tools. These machines and tools may be at least one of a robotic arm, a crawler, a fastener installation system, a rail-based drilling system, or a robot. Assembly equipment 2810 can be used to assemble parts such as seats, horizontal stabilizers, wings, engines, engine housings, landing gear systems, and other parts for aircraft 2700 in FIG. 27.

In this illustrative example, maintenance system 2804 includes maintenance equipment 2812. Maintenance equipment 2812 can include any equipment needed to perform maintenance on aircraft 2700 in FIG. 27. Maintenance equipment 2812 may include tools for performing different operations on parts on aircraft 2700 in FIG. 27. These operations can include at least one of disassembling parts, refurbishing parts, inspecting parts, reworking parts, manufacturing replacement parts, or other operations for performing maintenance on aircraft 2700 in FIG. 27. These operations can be for routine maintenance, inspections, upgrades, refurbishment, or other types of maintenance operations.

In the illustrative example, maintenance equipment 2812 may include ultrasonic inspection devices, x-ray imaging systems, vision systems, drills, crawlers, and other suitable devices. In some cases, maintenance equipment 2812 can include fabrication equipment 2808, assembly equipment 2810, or both to produce and assemble parts that are needed for maintenance.

Product management system 2800 also includes control system 2814. Control system 2814 is a hardware system and may also include software or other types of components. Control system 2814 is configured to control the operation of at least one of manufacturing system 2802 or maintenance system 2804. In particular, control system 2814 can control the operation of at least one of fabrication equipment 2808, assembly equipment 2810, or maintenance equipment 2812.

In one example, workflow manager 214 can be used in control system 2814 to control the operation of at least one of manufacturing system 2802 to manufacture parts for manufacturing aircraft or for use in maintenance system 2804 to maintain aircraft.

The hardware in control system 2814 can be implemented using hardware that may include computers, circuits, networks, and other types of equipment. The control may take the form of direct control of manufacturing equipment 2806. For example, robots, computer-controlled machines, and other equipment can be controlled by control system 2814. In other illustrative examples, control system 2814 can manage operations performed by human operators 2816 in manufacturing or performing maintenance on aircraft 2700. For example, control system 2814 can assign tasks, provide instructions, display models, or perform other operations to manage operations performed by human operators 2816. In these illustrative examples, workflow manager 214 in FIG. 2 can be implemented in control system 2814 to manage at least one of the manufacturing or maintenance of aircraft 2700 in FIG. 27.

In the different illustrative examples, human operators 2816 can operate or interact with at least one of manufacturing equipment 2806, maintenance equipment 2812, or control system 2814. This interaction can occur to manufacture aircraft 2700 in FIG. 27.

Of course, product management system 2800 may be configured to manage other products other than aircraft 2700 in FIG. 27. Although product management system 2800 has been described with respect to manufacturing in the aerospace industry, product management system 2800 can be configured to manage products for other industries. For example, product management system 2800 can be configured to manufacture products for the automotive industry as well as any other suitable industries.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A manufacturing system comprising:
a computer system;
a workflow manager in the computer system, wherein the workflow manager is configured to perform operations for a workflow to manufacture a part in which the operations comprise:
creating a job to manufacture the part using a numeric control machine;
creating a standardized computer-aided design model in a standardized format from a computer-aided design model for the part, wherein the standardized computer-aided design model includes product manufacturing information and geometry for the part;
storing the standardized computer-aided design model in a digital thread;
creating a mesh model in a finite element analysis format utilized by a finite element analysis program using the standardized computer-aided design model;
running a finite element analysis simulation for the part using the mesh model and finite element analysis program to obtain finite element analysis simulation results;
storing the finite element analysis simulation results from the finite element analysis simulation in the standardized format in the digital thread;
creating a numeric control program in a numeric control machine format utilized by the numeric control machine using the standardized computer-aided design model;
performing a manufacturing simulation of the part using the numeric control program and the numeric control machine to generate manufacturing simulation results in the standardized format;
storing the manufacturing simulation results in the standardized format in the digital thread; and
manufacturing the part using the numeric control program and the numeric control machine.

2. The manufacturing system of claim 1, wherein the workflow manager is configured to perform the operations for the workflow to manufacture the part in which the operations further comprise:
inspecting the part using an inspection system to generate inspection results; and
saving the inspection results in the standardized format in the digital thread.

3. The manufacturing system of claim 1, wherein the workflow manager is configured to perform the operations for the workflow to manufacture the part in which the operations further comprise:
performing cost modeling for the part using the manufacturing simulation results to create quote information; and
storing the quote information in the standardized format in the digital thread.

4. The manufacturing system of claim 2, wherein the workflow manager is configured to perform the operations for the workflow to manufacture the part in which the operations further comprise:
saving metadata generated during the workflow in the digital thread for the part.

5. The manufacturing system of claim 1, wherein the workflow manager is configured to perform the operations for the workflow to manufacture the part in which the operations further comprise:
creating electronic shop documentation using the manufacturing simulation results.

6. The manufacturing system of claim 1, wherein in creating the standardized computer-aided design model, wherein the workflow manager is configured to perform the operations comprising:
converting the computer-aided design model for the part to the standardized computer-aided design model in the standardized format;
performing a metafeature analysis using the computer-aided design model opened in a computer-aided design system to obtain parametric features for the part; and
storing the parametric features in the product manufacturing information in the standardized computer-aided design model.

7. The manufacturing system of claim 1, wherein in creating the numeric control program, the workflow manager is configured to perform the operations comprising:
creating a selected computer-aided design model in a computer-aided manufacturing format utilized by a computer-aided manufacturing system using the standardized computer-aided design model;
creating a computer-aided manufacturing model in the computer-aided manufacturing system using the product manufacturing information and the geometry in the computer-aided design model in the computer-aided manufacturing format;
creating the numeric control program in the numeric control machine format utilized by the numeric control machine using the product manufacturing information and the geometry in the computer-aided manufacturing model; and
storing the computer-aided manufacturing model with the product manufacturing information and the geometry in the standardized format in the digital thread.

8. The manufacturing system of claim 7 further comprising:
a machine learning model system comprising a number of machine learning models trained to optimize the numeric control program for manufacturing the part; and
wherein in creating the numeric control program in the numeric control machine format, the workflow manager is configured to perform the operations comprising:
creating the numeric control program in the numeric control machine format utilized by the numeric control machine using the standardized computer-aided design model; and
optimizing the numeric control program using the machine learning model system.

9. The manufacturing system of claim 8, wherein the number of machine learning models is trained using a training dataset comprising prior numeric program code and machining data for the part.

10. The manufacturing system of claim 1 further comprising:
a human machine interface;
wherein the workflow manager is configured to perform the operations for the workflow to manufacture the part in which the operations further comprise:
displaying the manufacturing simulation on the human machine interface; and
displaying the manufacturing simulation results on the human machine interface.

11. The manufacturing system of claim 1, wherein the product manufacturing information comprises at least one of parametric features, geometric data, materials, tolerances, stock dimensions, or tooling information.

12. The manufacturing system of claim 1, wherein the numeric control machine is selected from a group comprising a two dimensional numeric control machine, a three dimensional numeric control machine, a milling machine, a lathe, a plasma cutter, a laser cutter, and a water jet cutter.

13. The manufacturing system of claim 1, wherein the standardized computer-aided design model is a Base Level Standard for the Exchange of Product Data (STEP) file.

14. A manufacturing system comprising:
a computer system;
a digital thread in the computer system, wherein the digital thread stores information for manufacturing a workpiece, wherein the information in the digital thread is in a standardized format; and
a workflow manager in the computer system, wherein the workflow manager is configured to perform operations for a workflow to manufacture the workpiece in which the operations comprise:
creating a job to manufacture the workpiece using a numeric control machine, wherein the job identifies tasks in the workflow to manufacture the workpiece;
creating a standardized computer-aided design model in the standardized format from a computer-aided design model for the workpiece, wherein the standardized computer-aided design model is stored in the digital thread;
performing a number of simulations in the workflow using information in the digital thread used as inputs to a number of simulators to obtain simulation results, wherein the information is in a simulator format used by each of the number of simulators and wherein the simulation results are stored in the standardized format in the digital thread;
creating a numeric control program in a numeric control machine format utilized by the numeric control machine using product manufacturing information and geometry for the workpiece in the standardized computer-aided design model in the digital thread; and
manufacturing the workpiece using the numeric control program and the numeric control machine.

15. The manufacturing system of claim 14, wherein the workflow manager is configured to perform the operations for the workflow to manufacture the workpiece in which the operations further comprise:
inspecting the workpiece using an inspection system to generate inspection results; and
saving the inspection results in the standardized format in the digital thread.

16. The manufacturing system of claim 14, wherein the workflow manager is configured to perform the operations for the workflow to manufacture the workpiece in which the operations further comprise:
performing cost modeling for using the simulation results to create quote information; and
storing the quote information in the standardized format in the digital thread.

17. The manufacturing system of claim 14, wherein the workflow manager is configured to perform the operations further comprising:
creating electronic shop documentation using the simulation results.

18. The manufacturing system of claim 14, wherein in performing the number of simulations in the workflow, the workflow manager is configured to perform the operations comprising:
creating simulation information from the information in the digital thread as inputs to the number of simulators, wherein the simulation information is the simulator format utilized by each of the number of simulators;
sending the simulation information as the inputs to the number of simulators;
initiating the number of simulators to perform the number of simulations for the workpiece using the simulation information to obtain the simulation results; and
storing simulation results in the standardized format in the digital thread.

19. The manufacturing system of claim 14, wherein in performing the number of simulations in the workflow, the workflow manager is configured to perform the operations comprising:
creating a mesh model in a finite element analysis format utilized by a finite element analysis program using the standardized computer-aided design model;
performing a finite element analysis simulation for the workpiece using the mesh model and finite element analysis program to obtain finite element analysis simulation results; and
storing the finite element analysis simulation results from the finite element analysis simulation in the standardized format in the digital thread.

20. The manufacturing system of claim 14, wherein in performing the number of simulations in the workflow, the workflow manager is configured to perform the operations comprising:
creating the numeric control program for the numeric control machine using the product manufacturing information and the geometry in the standardized computer-aided design model;
performing a manufacturing simulation of the workpiece using the numeric control program for the numeric control machine to obtain manufacturing simulation results; and
storing the manufacturing simulation results from the manufacturing simulation in the standardized format in the digital thread.

21. The manufacturing system of claim 14, wherein in manufacturing the workpiece, the workflow manager is configured to perform the operations comprising:
sending the numeric control program in the numeric control machine format utilized by the numeric control machine as an input to the numeric control machine;
initiating manufacturing of the workpiece by the numeric control machine using the numeric control program;
receiving manufacturing results from the numeric control machine; and
storing the manufacturing results in the standardized format in the digital thread.

22. The manufacturing system of claim 14, wherein in creating the numeric control program, the workflow manager is configured to perform the operations comprising:
creating a computer-aided design model in a computer-aided manufacturing format utilized by a computer-aided manufacturing system using the standardized computer-aided design model;
creating a computer-aided manufacturing model in the computer-aided manufacturing system using the product manufacturing information and the geometry in the computer-aided design model in the computer-aided manufacturing format;
creating the numeric control program in the numeric control machine format utilized by the numeric control machine using the product manufacturing information and the geometry in the computer-aided manufacturing model; and
storing the computer-aided manufacturing model with the product manufacturing information and the geometry in the standardized format in the digital thread.

23. The manufacturing system of claim 22 further comprising:
a machine learning model system comprising a number of machine learning models trained to optimize the numeric control program for manufacturing the workpiece; and
wherein creating the numeric control program in the numeric control machine format, the workflow manager is configured to perform the operations comprising:
creating the numeric control program in the numeric control machine format utilized by the numeric control machine using the standardized computer-aided design model; and
optimizing the numeric control program using the machine learning model system.

24. The manufacturing system of claim 23, wherein the number of machine learning models is trained using a training dataset comprising prior numeric program code and manufacturing data for the workpiece.

25. The manufacturing system of claim 14 further comprising:
a human machine interface;
wherein the workflow manager is configured to perform the operations for the workflow to manufacture the workpiece in which the operations further comprise:
displaying the number of simulations on the human machine interface; and
displaying the simulation results on the human machine interface.

26. The manufacturing system of claim 14, wherein the numeric control machine is selected from a group comprising a two dimensional numeric control machine, a three dimensional numeric control machine, a milling machine, a lathe, a plasma cutter, a laser cutter, a water jet cutter, an automated tape laying machine, and an automated fiber laying machine.

27. The manufacturing system of claim 14, wherein the workpiece is selected from a group comprising a finished part and an unfinished part.

28. A method for manufacturing a part, the method comprising:
creating a job as part of a workflow to manufacture the part using a numeric control machine;
creating a standardized computer-aided design model in a standardized format from a computer-aided design model for the part, wherein the standardized computer-aided design model includes product manufacturing information and geometry for the part;
storing the standardized computer-aided design model in a digital thread;
creating a mesh model in a finite element analysis format utilized by a finite element analysis program using the standardized computer-aided design model;
running a finite element analysis simulation for the part using the mesh model and finite element analysis program to obtain finite element analysis simulation results;
storing the finite element analysis simulation results from the finite element analysis simulation in the standardized format in the digital thread;
creating a numeric control program in a numeric control machine format utilized by the numeric control machine using the standardized computer-aided design model;
performing a manufacturing simulation of the part using the numeric control program for the numeric control machine to generate manufacturing simulation results in the standardized format;
storing the manufacturing simulation results in the standardized format in the digital thread; and
manufacturing the part using the numeric control program and the numeric control machine.

29. The method of claim 28 further comprising:
inspecting the part using an inspection system to generate inspection results; and
saving the inspection results in the standardized format in the digital thread.

30. The method of claim 28 further comprising:
performing cost modeling for the part using the manufacturing simulation results to create quote information; and
storing the quote information in the standardized format in the digital thread.

31. The method of claim 29 further comprising:
saving metadata generated during the workflow in the digital thread for the part.

32. The method of claim 28 further comprising:
creating electronic shop documentation using the manufacturing simulation results.

33. The method of claim 28, wherein creating the standardized computer-aided design model comprises:
converting the computer-aided design model for the part to the standardized computer-aided design model in the standardized format;
performing a metafeature analysis using the computer-aided design model opened in a computer-aided design system to obtain parametric features for the part; and
storing the parametric features in the product manufacturing information in the standardized computer-aided design model.

34. The method of claim 28, creating the numeric control program comprises:
creating a selected computer-aided design model in a computer-aided manufacturing format utilized by a computer-aided manufacturing system using the standardized computer-aided design model;
creating a computer-aided manufacturing model in the computer-aided manufacturing system using the product manufacturing information and the geometry in the computer-aided design model in the computer-aided manufacturing format;
creating the numeric control program in the numeric control machine format utilized by the numeric control machine using the product manufacturing information and the geometry in the computer-aided manufacturing model; and
storing the computer-aided manufacturing model with the product manufacturing information and the geometry in the standardized format in the digital thread.

35. The method of claim 28, wherein creating the numeric control program in the numeric control machine format comprises:
creating the numeric control program in the numeric control machine format utilized by the numeric control machine using the standardized computer-aided design model; and
optimizing the numeric control program using a machine learning model system.

36. The method of claim 28 further comprising:
displaying the manufacturing simulation on a human machine interface; and
displaying the manufacturing simulation results on the human machine interface.

37. A method for manufacturing a workpiece, the method comprising:
creating a job as part of a workflow to manufacture the workpiece using a numeric control machine, wherein the job identifies tasks in the workflow to manufacture the workpiece;
creating a standardized computer-aided design model in a standardized format from a computer-aided design model for the workpiece, wherein the standardized computer-aided design model is stored in a digital thread;
performing a number of simulations in the workflow using information in the digital thread used as inputs to a number of simulators to obtain simulation results, wherein the information is in a simulator format used by each of the number of simulators and wherein the simulation results are stored in the standardized format in the digital thread;
creating a numeric control program in a numeric control machine format utilized by the numeric control machine using product manufacturing information and geometry for the workpiece in the standardized computer-aided design model in the digital thread; and
manufacturing the workpiece using the numeric control program and the numeric control machine.

38. The method of claim 37 further comprising:
inspecting the workpiece using an inspection system to generate inspection results; and
saving the inspection results in the standardized format in the digital thread.

39. The method of claim 37 further comprising:
performing cost modeling for using the simulation results to create quote information; and
storing the quote information in the standardized format in the digital thread.

40. The method of claim 37, wherein performing the number of simulations in the workflow comprises:
creating simulation information from the information in the digital thread as inputs to the number of simulators, wherein the simulation information is the simulator format utilized by each of the number of simulators;
sending the simulation information as the inputs to the number of simulators;
initiating the number of simulators to perform the number of simulations for the workpiece using the simulation information to obtain the simulation results; and
storing simulation results in the standardized format in the digital thread.

41. The method of claim 37, wherein performing the number of simulations in the workflow comprises:
creating a mesh model in a finite element analysis format utilized by a finite element analysis program using the standardized computer-aided design model;
performing a finite element analysis simulation for the workpiece using the mesh model and finite element analysis program to obtain finite element analysis simulation results; and
storing the finite element analysis simulation results from the finite element analysis simulation in the standardized format in the digital thread.

42. The method of claim 37, wherein performing the number of simulations in the workflow comprises:
performing a manufacturing simulation of the workpiece using the numeric control program and the numeric control machine to obtain manufacturing simulation results; and
storing the manufacturing simulation results from the manufacturing simulation in the standardized format in the digital thread.

43. The method of claim 37, wherein manufacturing the workpiece comprises:
sending the numeric control program in the numeric control machine format utilized by the numeric control machine as an input to the numeric control machine;
initiating manufacturing of the workpiece by the numeric control machine using the numeric control program;
receiving manufacturing results from the numeric control machine; and
storing the manufacturing results in the standardized format in the digital thread.

44. The method of claim 37, creating the numeric control program comprises:
creating a computer-aided design model in a computer-aided manufacturing format utilized by a computer-aided manufacturing system using the standardized computer-aided design model;
creating a computer-aided manufacturing model in the computer-aided manufacturing system using the product manufacturing information and the geometry in the computer-aided design model in the computer-aided manufacturing format;
creating the numeric control program in the numeric control machine format utilized by the numeric control machine using the product manufacturing information and the geometry in the standardized computer-aided design model; and
storing the computer-aided manufacturing model with the product manufacturing information and the geometry in the standardized format in the digital thread.

45. The method of claim 37, wherein creating the numeric control program in the numeric control machine format comprises:
creating the numeric control program in the numeric control machine format utilized by the numeric control machine using the standardized computer-aided design model; and
optimizing the numeric control program using a machine learning model system.

46. A computer program product for manufacturing a workpiece, the computer program product comprising:
a set of one or more computer-readable storage media;
program instructions stored on the set of one or more storage media to perform operations comprising:
creating a job as part of a workflow to manufacture the workpiece using a numeric control machine, wherein the job identifies tasks in the workflow to manufacture the workpiece;
creating a standardized computer-aided design model in a standardized format from a computer-aided design model for the workpiece, wherein the standardized computer-aided design model is stored in a digital thread;
performing a number of simulations in the workflow using information in the digital thread used as inputs to a number of simulators to obtain simulation results, wherein the information is in a simulator format used by each of the number of simulators and wherein the simulation results are stored in the standardized format in the digital thread;
creating a numeric control program in a numeric control machine format utilized by the numeric control machine using product manufacturing information and geometry for the workpiece in the standardized computer-aided design model in the digital thread; and
manufacturing the workpiece using the numeric control program and the numeric control machine.
